(19) United States
(12) Patent Application Publication
(10) Pub. No.: US 2024/0430879 A1
(43) Pub. Date: Dec. 26, 2024

(54) INDICATION OF UNUSED ENERGY TRANSFER OR ENERGY HARVESTING OCCASIONS

(71) Applicant: QUALCOMM Incorporated, San Diego, CA (US)

(72) Inventors: Ahmed ELSHAFIE, San Diego, CA (US); Huilin XU, Temecula, CA (US); Linhai HE, San Diego, CA (US); Diana MAAMARI, San Diego, CA (US)

(21) Appl. No.: 18/341,582

(22) Filed: Jun. 26, 2023

(51) Int. Cl. H04W 72/12; H02J 50/00; H04W 72/20

(52) U.S. Cl. CPC H04W 72/12; H02J 50/001; H04W 72/20

(57) ABSTRACT

Methods, systems, and devices for wireless communications are described. Energy harvesting (EH)-capable devices may receive power from transmissions by other devices. The network may schedule a user equipment (UE) to provide an energy transfer transmission to an EH-capable device. The UE may be unable to perform the scheduled energy transfer transmission. A UE scheduled to perform an energy transfer transmission to an EH-capable device may transmit an indication to the network, the EH-capable device, or another UE that the UE will skip the scheduled energy transfer transmission. In response, the EH-capable device may not monitor for the scheduled energy transfer transmission, the network may schedule a different resource for an energy transfer transmission by the UE, the network may schedule a different UE to perform an energy transfer transmission to the EH-capable device, and/or another UE which received the indication may perform an energy transfer transmission to the EH-capable device.

### INTRODUCTION

The following relates to wireless communications that pertain to indications of unused energy transfer or energy harvesting occasions.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support indication of unused energy transfer or energy harvesting occasions. For example, the described techniques provide for transmission by an energy providing device, such as a user equipment (UE), that the energy providing device will skip a scheduled energy transfer transmission to an energy harvesting (EH)-capable device. EH-capable devices may receive power from transmissions by other devices. In some wireless communications systems, the network may schedule a network device such as a UE to provide an energy transfer transmission to an EH-capable device. In some cases, the UE may be unable to perform the scheduled energy transfer transmission, for example, because of a scheduling conflict. A UE that is scheduled to perform an energy transfer transmission to an EH-capable device may transmit an indication to the network, the EH-capable device, or another UE that the UE will skip the scheduled energy transfer transmission. In response to the indication, the EH-capable device may not monitor for the scheduled energy transfer transmission, the network may schedule a different resource for an energy transfer transmission to the EH-capable device by the UE, the network may schedule a different UE to perform an energy transfer transmission to the EH-capable device, and/or another UE which received the indication may perform an energy transfer transmission to the EH-capable device.

A method for wireless communications by a first network entity is described. The method may include receiving first control information that schedules an energy transfer transmission from the first network entity to an EH-capable device and transmitting first information including an indication that that the first network entity will skip performance of at least a portion of the energy transfer transmission scheduled by the first control information.

A first network entity for wireless communications is described. The first network entity may include at least one communication interface; and at least one processor coupled to the at least one communication interface, where the first network entity is configured to receive first control information that schedules an energy transfer transmission from the first network entity to an EH-capable device and transmit first information including an indication that that the first network entity will skip performance of at least a portion of the energy transfer transmission scheduled by the first control information.

Another first network entity for wireless communications is described. The first network entity may include means for receiving first control information that schedules an energy transfer transmission from the first network entity to an EH-capable device and means for transmitting first information including an indication that that the first network entity will skip performance of at least a portion of the energy transfer transmission scheduled by the first control information.

A non-transitory computer-readable having code for wireless communication stored thereon is described. The code, when executed by a first network entity, causes the first network entity to receive first control information that schedules an energy transfer transmission from the first network entity to an EH-capable device and transmit first information including an indication that that the first network entity will skip performance of at least a portion of the energy transfer transmission scheduled by the first control information.

Some examples of the method, first network entities, and non-transitory computer-readable medium described herein may further include operations, features, means, or instructions for receiving second control information indicative of a communication resource for transmission of the first information.

In some examples of the method, first network entities, and non-transitory computer-readable medium described herein, the first control information schedules a set of multiple energy transfer transmissions from the first network entity to the EH-capable device and the set of multiple energy transfer transmissions includes the energy transfer transmission.

In some examples of the method, first network entities, and non-transitory computer-readable medium described herein, the first control information schedules the energy transfer transmission in a set of communication resources and the portion may be a first subset of communication resources of the set of communication resources.

Some examples of the method, first network entities, and non-transitory computer-readable medium described herein may further include operations, features, means, or instructions for performing the energy transfer transmission via a second subset of the set of communication resources.

In some examples of the method, first network entities, and non-transitory computer-readable medium described herein, the first control information schedules the energy transfer transmission in a first set of communication resources and the first information includes an indication of a second set of communication resources in which the first network entity may be capable of a second energy transfer transmission from the first network entity to the EH-capable device.

In some examples of the method, first network entities, and non-transitory computer-readable medium described herein, the first information includes an indication of a set of network entities capable of energy transfer transmissions to the EH-capable device.

Some examples of the method, first network entities, and non-transitory computer-readable medium described herein may further include operations, features, means, or instructions for receiving second control information that schedules a second energy transfer transmission from the first network entity to the EH-capable device, where the second control information includes an indication for the first network entity to transmit second information if the first network entity will perform the second energy transfer transmission, where the second information indicates that the first network entity will transmit the second energy transfer transmission, and where the first control information includes an indication for the first network entity to transmit the first information if the first network entity will skip performance of the energy transfer transmission, transmitting the second information, and performing the second energy transfer transmission.

Some examples of the method, first network entities, and non-transitory computer-readable medium described herein may further include operations, features, means, or instructions for receiving, from the EH-capable device, second information including a first indication to skip performance of the energy transfer transmission, where transmitting the first information may be based on the second information.

Some examples of the method, first network entities, and non-transitory computer-readable medium described herein may further include operations, features, means, or instructions for performing a second energy transfer transmission a period of time after the scheduled energy transfer transmission, where the second information includes a request for performance of the second energy transfer transmission after the period of time after the scheduled energy transfer transmission.

In some examples of the method, first network entities, and non-transitory computer-readable medium described herein, the second information indicates a second set of communication resources for performance of the second energy transfer transmission, the first control information schedules the energy transfer transmission in a first set of communication resources, and the second set of communication resources may be subsequent to the first set of communication resources by the period of time.

In some examples of the method, first network entities, and non-transitory computer-readable medium described herein, the second information indicates the period of time using a unit of time in accordance with a codebook.

In some examples of the method, first network entities, and non-transitory computer-readable medium described herein, the second information indicates a component carrier for performance of the second energy transfer transmission after the period of time, a frequency band for performance of the second energy transfer transmission after the period of time, a transmission configuration indicator state for performance of the second energy transfer transmission after the period of time, a source network entity to perform the second energy transfer transmission after the period of time, an energy harvesting configuration associated with the second energy transfer transmission, or a combination thereof.

In some examples of the method, first network entities, and non-transitory computer-readable medium described herein, transmitting the first information may include operations, features, means, or instructions for transmitting the first information to the EH-capable device, a second network entity from which the first network entity received the first control information, or a third network entity capable of performance of a second energy transfer transmission to the EH-capable device.

A method for wireless communications by an EH-capable device is described. The method may include receiving first control information that schedules an energy transfer transmission from a first network entity to the EH-capable device and receiving, from the first network entity, first information including an indication that the first network entity will skip performance of at least a portion of the energy transfer transmission scheduled by the first control information.

An EH-capable device for wireless communications is described. The EH-capable device may include at least one communication interface; and at least one processor coupled to the at least one communication interface, where the EH-capable device is configured to receive first control information that schedules an energy transfer transmission from a first network entity to the EH-capable device and receive, from the first network entity, first information including an indication that the first network entity will skip performance of at least a portion of the energy transfer transmission scheduled by the first control information.

Another EH-capable device for wireless communications is described. The EH-capable device may include means for receiving first control information that schedules an energy transfer transmission from a first network entity to the EH-capable device and means for receiving, from the first network entity, first information including an indication that the first network entity will skip performance of at least a portion of the energy transfer transmission scheduled by the first control information.

A non-transitory computer-readable having code for wireless communication stored thereon is described. The code, when executed by an EH-capable device, causes the EH-capable device to receive first control information that schedules an energy transfer transmission from a first network entity to the EH-capable device and receive, from the first network entity, first information including an indication that the first network entity will skip performance of at least a portion of the energy transfer transmission scheduled by the first control information.

Some examples of the method, EH-capable devices, and non-transitory computer-readable medium described herein may further include operations, features, means, or instructions for transmitting, to the first network entity, second information including a first indication to skip the energy transfer transmission, where the first information may be responsive to the second information.

Some examples of the method, EH-capable devices, and non-transitory computer-readable medium described herein may further include operations, features, means, or instructions for identifying that an energy level of the EH-capable device satisfies a threshold, where transmitting the second information may be based on the identification.

Some examples of the method, EH-capable devices, and non-transitory computer-readable medium described herein may further include operations, features, means, or instructions for receiving scheduling information for a communication, where the communication conflicts with the energy transfer transmission, and where transmitting the second information may be based on the communication conflicting with the energy transfer transmission.

Some examples of the method, EH-capable devices, and non-transitory computer-readable medium described herein may further include operations, features, means, or instructions for receiving a second energy transfer transmission after a period of time after the scheduled energy transfer transmission, where the second information includes a request for performance of the second energy transfer transmission after the period of time after the scheduled energy transfer transmission.

In some examples of the method, EH-capable devices, and non-transitory computer-readable medium described herein, the second information includes an indication of a second set of communication resources for performance of the second energy transfer transmission, the first control information schedules the energy transfer transmission in a first set of communication resources, and the second set of communication resources may be subsequent to the first set of communication resources by the period of time.

In some examples of the method, EH-capable devices, and non-transitory computer-readable medium described herein, the second information indicates the period of time using a unit of time in accordance with a codebook.

In some examples of the method, EH-capable devices, and non-transitory computer-readable medium described herein, the second information includes an indication of a component carrier for performance of the second energy transfer transmission after the period of time, a frequency band for performance of the second energy transfer transmission after the period of time, a transmission configuration indicator state for performance of the second energy transfer transmission after the period of time, a source network entity to perform the second energy transfer transmission after the period of time, an energy harvesting configuration associated with the second energy transfer transmission, or a combination thereof.

In some examples of the method, EH-capable devices, and non-transitory computer-readable medium described herein, the first control information schedules a set of multiple energy transfer transmissions from the first network entity to the EH-capable device and the set of multiple energy transfer transmissions includes the energy transfer transmission.

In some examples of the method, EH-capable devices, and non-transitory computer-readable medium described herein, the first control information schedules the energy transfer transmission in a set of communication resources and the portion may be a first subset of communication resources of the set of communication resources.

Some examples of the method, EH-capable devices, and non-transitory computer-readable medium described herein may further include operations, features, means, or instructions for receiving the energy transfer transmission via a second subset of the set of communication resources.

In some examples of the method, EH-capable devices, and non-transitory computer-readable medium described herein, the first control information schedules the energy transfer transmission in a first set of communication resources and the first information includes an indication of a second set of communication resources in which the first network entity may be capable of performance of a second energy transfer transmission from the first network entity to the EH-capable device.

A method for wireless communications by a first network entity is described. The method may include transmitting, to a second network entity, first control information that schedules an energy transfer transmission from the second network entity to an EH-capable device and receiving, from the second network entity, first information including an indication that the second network entity will skip performance of at least a portion of the energy transfer transmission scheduled by the first control information.

A first network entity for wireless communications is described. The first network entity may at least one communication interface; and at least one processor coupled to the at least one communication interface, where the first network entity is configured to transmit, to a second network entity, first control information that schedules an energy transfer transmission from the second network entity to an EH-capable device and receive, from the second network entity, first information including an indication that the second network entity will skip performance of at least a portion of the energy transfer transmission scheduled by the first control information.

Another first network entity for wireless communications is described. The first network entity may include means for transmitting, to a second network entity, first control information that schedules an energy transfer transmission from the second network entity to an EH-capable device and means for receiving, from the second network entity, first information including an indication that the second network entity will skip performance of at least a portion of the energy transfer transmission scheduled by the first control information.

A non-transitory computer-readable having code for wireless communication stored thereon is described. The code, when executed by a first network entity, causes the first network entity to transmit, to a second network entity, first control information that schedules an energy transfer transmission from the second network entity to an EH-capable device and receive, from the second network entity, first information including an indication that the second network entity will skip performance of at least a portion of the energy transfer transmission scheduled by the first control information.

Some examples of the method, first network entities, and non-transitory computer-readable medium described herein may further include operations, features, means, or instructions for transmitting, to the second network entity, second control information indicative of a communication resource for transmission of the first information, where the first information may be received via the communication resource.

In some examples of the method, first network entities, and non-transitory computer-readable medium described herein, the first control information schedules a set of multiple energy transfer transmissions from the second network entity to the EH-capable device and the set of multiple energy transfer transmissions includes the energy transfer transmission.

In some examples of the method, first network entities, and non-transitory computer-readable medium described herein, the first control information schedules the energy transfer transmission in a set of communication resources and the portion may be a first subset of communication resources of the set of communication resources.

Some examples of the method, first network entities, and non-transitory computer-readable medium described herein may further include operations, features, means, or instructions for transmitting second control information that schedules a second energy transfer transmission from the second network entity to the EH-capable device in a second set of communication resources, where the first control information schedules the energy transfer transmission in a first set of communication resources, where the first information indicates the second set of communication resources in which the second network entity may be capable of performance of the second energy transfer transmission from the second network entity to the EH-capable device.

Some examples of the method, first network entities, and non-transitory computer-readable medium described herein may further include operations, features, means, or instructions for receiving, from the second network entity, an indication of a set of network entities capable of performance of energy transfer transmissions to the EH-capable device and transmitting, to one of the set of network entities, second control information that schedules a second energy transmission from the one of the set of network entities to the EH-capable device.

Some examples of the method, first network entities, and non-transitory computer-readable medium described herein may further include operations, features, means, or instructions for receiving, from the EH-capable device, second information that indicates to skip the energy transfer transmission and transmitting, to the second network entity in response to the second information, second control information that indicates to skip the energy transfer transmission, where the first information may be responsive to the second control information.

Some examples of the method, first network entities, and non-transitory computer-readable medium described herein may further include operations, features, means, or instructions for transmitting, to the second network entity, second control information that schedules a second energy transfer transmission from the second network entity to the EH-capable device, where the second control information includes an indication for the second network entity to transmit second information if the second network entity will perform the second energy transfer transmission, where the second information indicates that the second network entity will transmit the second energy transfer transmission, and where the first control information includes an indication for the second network entity to transmit the first information if the second network entity will skip performance of the energy transfer transmission and receiving, from the second network entity, the second information that indicates the second network entity will perform the second energy transfer transmission.

### BRIEF DESCRIPTION OF THE DRAWINGS

FIG. 1 shows an example of a wireless communications system that supports indication of unused energy transfer or energy harvesting (EH) occasions in accordance with one or more aspects of the present disclosure.

FIG. 2 shows an example of a wireless communications system that supports indication of unused energy transfer or EH occasions in accordance with one or more aspects of the present disclosure.

FIG. 3 shows an example of a process flow that supports indication of unused energy transfer or EH occasions in accordance with one or more aspects of the present disclosure.

FIGS. 4 and 5 show block diagrams of devices that support indication of unused energy transfer or EH occasions in accordance with one or more aspects of the present disclosure.

FIG. 6 shows a block diagram of a communications manager that supports indication of unused energy transfer or EH occasions in accordance with one or more aspects of the present disclosure.

FIG. 7 shows a diagram of a system including a device that supports indication of unused energy transfer or EH occasions in accordance with one or more aspects of the present disclosure.

FIGS. 8 and 9 show block diagrams of devices that support indication of unused energy transfer or EH occasions in accordance with one or more aspects of the present disclosure.

FIG. 10 shows a block diagram of a communications manager that supports indication of unused energy transfer or EH occasions in accordance with one or more aspects of the present disclosure.

FIG. 11 shows a diagram of a system including a device that supports indication of unused energy transfer or EH occasions in accordance with one or more aspects of the present disclosure.

FIGS. 12 through 14 show flowcharts illustrating methods that support indication of unused energy transfer or EH occasions in accordance with one or more aspects of the present disclosure.

### DETAILED DESCRIPTION

Some wireless communications systems may include energy harvesting (EH)-capable devices to perform operations such as location tracking and identification. Some EH-capable devices may receive power from transmissions by other devices. In some wireless communications systems, the network may schedule a network device such as a user equipment (UE) or other power radiating device to provide an energy transfer transmission to an EH-capable device. For example, an energy transfer transmission may be a radio frequency (RF) transmission or a laser transmission. In some cases, the UE may be unable to perform the scheduled energy transfer transmission, for example, because of a scheduling conflict. The network and the EH-capable device may be unaware that the UE will not perform the scheduled energy transfer transmission. Thus, the EH-capable device may waste energy monitoring for the scheduled energy transfer transmission and may not receive the energy transfer transmission used to power the EH-capable device. Further, the network may not schedule a different resource for the UE for the energy transfer transmission or may not schedule a different UE to perform the energy transfer transmission. Additionally, or alternatively, an EH-capable device may determine to skip a scheduled energy transfer monitoring occasion, for example, due to a scheduling conflict or if the EH-capable device already has sufficient energy. If the energy providing UE is unaware that the EH-capable device will skip the energy transfer monitoring occasion, the energy providing UE may waste energy and communication resources by performing the corresponding scheduled energy transfer transmission.

A UE that is scheduled to perform an energy transfer transmission to an EH-capable device may transmit an indication to the network, the EH-capable device, or another UE that the UE will skip the scheduled energy transfer transmission. In some aspects, in response to the indication, the EH-capable device may not monitor for the scheduled energy transfer transmission, the network may schedule a different resource for an energy transfer transmission to the EH-capable device by the UE, the network may schedule a different UE to perform an energy transfer transmission to the EH-capable device, and/or another UE which received the indication may perform an energy transfer transmission to the EH-capable device. In some aspects, the UE may indicate, with the “skipping” indication, a preferred time or set of resources for performing an energy transfer transmission to the EH-capable device, and the network may schedule a future energy transfer transmission to the EH-capable device based on the indication of the preferred time or set of resources. In some aspects, the EH-capable device may transmit an indication that the EH-capable device will skip a scheduled energy transfer monitoring occasion. In some aspects, the EH-capable device may indicate a preferred time or set of resources for an energy transfer transmission along with the indication that the EH-capable device will skip a scheduled energy transfer monitoring occasion. In some aspects, in response to receiving the indication that the EH-capable device will skip a scheduled energy transfer monitoring occasion, the energy providing UE may transmit an indication that the UE will skip the corresponding scheduled energy transfer transmission. In some aspects, in response to receiving the indication that the EH-capable device will skip a scheduled energy transfer monitoring occasion, the network may transmit control signaling to the energy providing UE indicating for the energy providing UE to skip the corresponding scheduled energy transfer transmission.

Aspects of the disclosure are initially described in the context of wireless communications systems. Aspects of the disclosure are further illustrated by and described with reference to process flows, apparatus diagrams, system diagrams, and flowcharts that relate to indication of unused energy transfer or EH occasions.

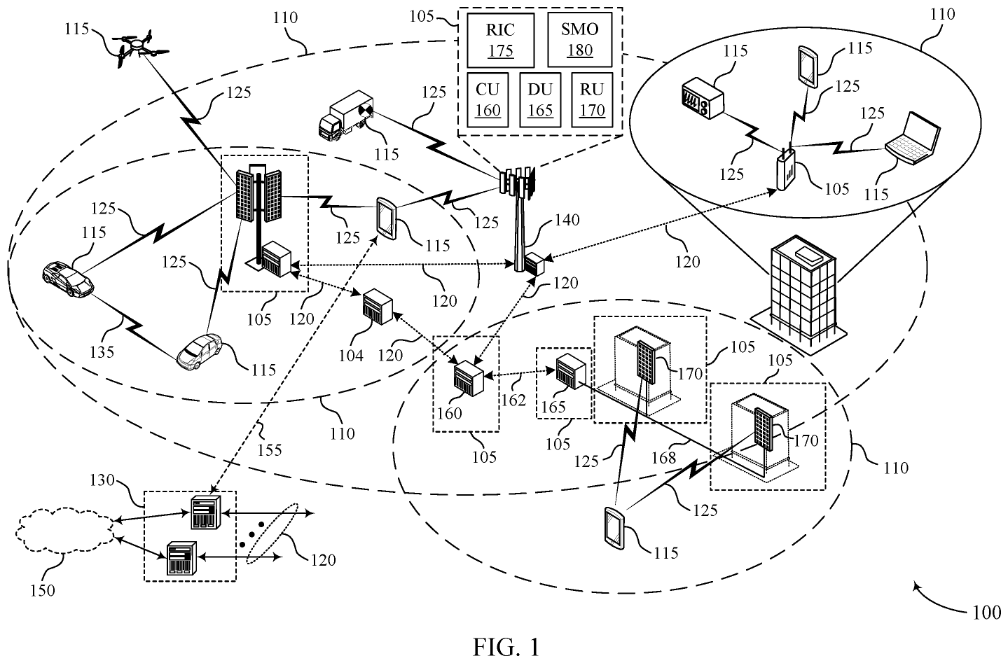

FIG. 1 shows an example of a wireless communications system 100 that supports indication of unused energy transfer or EH occasions in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support indication of unused energy transfer or EH occasions as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers (CCs) and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Ts=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple CCs.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may include EH-capable devices such as ambient IoT (AIoT) devices or active or semi-passive radio frequency identification (RFID) tags to perform operations such as location tracking and identification. EH-capable devices may also be referred to as EH-capable UEs 115. EH-capable devices may receive power from transmissions by other devices. In some wireless communications systems, a serving network entity 105 may schedule a network device such as a UE 115 to provide an energy transfer transmission to an EH-capable device. In some cases, the UE 115 may be unable to perform the scheduled energy transfer transmission, for example, because of a scheduling conflict. Additionally, or alternatively, an EH-capable device may to skip a scheduled energy transfer monitoring occasion, for example, due to a scheduling conflict or if the EH-capable device already has sufficient energy.

A UE 115 that is scheduled to perform an energy transfer transmission to an EH-capable device may transmit an indication to the network entity 105, the EH-capable device, or another UE 115 that the UE 115 will skip the scheduled energy transfer transmission. In some aspects, in response to the indication, the EH-capable device may not monitor for the scheduled energy transfer transmission, the network entity 105 may schedule a different resource for an energy transfer transmission to the EH-capable device by the UE 115, the network entity 105 may schedule a different UE 115 to perform an energy transfer transmission to the EH-capable device, and/or another UE 115 which received the indication may perform an energy transfer transmission to the EH-capable device. In some aspects, the UE 115 may indicate, with the “skipping” indication, a preferred time or set of resources for performing an energy transfer transmission to the EH-capable device, and the network entity 105 may schedule a future energy transfer transmission to the EH-capable device based on the indication of the preferred time or set of resources.

In some aspects, an EH-capable device may transmit an indication that the EH-capable device will skip an energy transfer monitoring occasion. In some aspects, the EH-capable device may indicate a preferred time or set of resources for an energy transfer transmission along with the indication that the EH-capable device will skip a scheduled energy transfer monitoring occasion. In some aspects, in response to receiving the indication that the EH-capable device will skip a scheduled energy transfer monitoring occasion, the energy providing UE 115 may transmit an indication that the UE 115 will skip the corresponding scheduled energy transfer transmission. In some aspects, in response to receiving the indication that the EH-capable device will skip a scheduled energy transfer monitoring occasion, the network entity 105 may transmit control signaling to the energy providing UE 115 indicating for the energy providing UE 115 to skip the corresponding scheduled energy transfer transmission.

In some aspects, a new interface may be used for communications between an EH-capable device and one or more other network devices, such as UEs 115 or network entities 105. The new interface may be a communication system that may use a sine wave (single tone) or multi-tone (OFDM-based) waveform (RF waveforms) transmitted by a first device and reflected/backscattered by a second device (e.g., the EH-capable device). The first device may refer to a network unit, an IAB relay, a relay node, a RAN node, a gNB, a TRP associated with the network, a sidelink UE 115 (remote, primary, primary logic controller (PLC), or a controlling unit in sidelink), or a UE 115 that transmits a Uu link waveform or RF signals as described herein. The waveform generated by the first device may carry a data signal (e.g., physical downlink shared channel (PDSCH), physical uplink shared channel (PUSCH), physical sidelink shared channel (PSSCH)), a reference signal (e.g., CSI-RS, sounding reference signal (SRS), synchronization signal block (SSB)), or random data or reference signal signals/symbols across different sub-channels or resource elements. In some aspects, the waveform may be sub-channels modulated with OFDM signals or waveforms or time-domain modulated OFDM-based signals or waveforms. The communication signals in the new interface may refer to a modulated waveform or signal generated based on the capability of the EH-capable device by the EH-capable device, where the waveform may be one of a sine wave (single tone) or multi-tone wave (e.g., OFDM-based waveform). In some aspects, the modulation used can be on-off keying (OOK), amplitude-shift keying (ASK), frequency-shift keying (FSK), phase-shift keying (PSK), Zadoff Chu, DFT, Walshi/Hadamard modulation, Gold modulation, Reed-Solomon encoding, m-sequence encoding, or Chirp encoding, among other examples. In some aspects, modulation may occur in the time domain or the frequency domain, or jointly in the time and frequency domain. In some aspects, Manchester coding may be used with ASK or OOK. In some aspects, forward error correction codes and other channel coding may be applied to achieve higher reliability

In some aspects, a UE 115 may use two different interfaces. One interface (the first interface) may be associated with a high power mode (or no to low power saving mode) and may be associated with a Uu or PC5 like interfaces. Another interface (the second interface) may be associated with a same radio as the first interface with deactivation of one or more on RF, hardware, software, or firmware components, or may be associated with a separate radio (e.g., backscatter-based) radio similar to an RFID tag (passive or semi-passive). The second interface may be used with low to very low power saving modes (e.g., where the UE 115 maximizes the power saving). In some aspects, the interface used and type of signal may be associated. For example, if the signal is low priority or less important than data and regular or legacy uplink signals (e.g., HARQ-ACK, CSI report), the second interface may be used. If the signal is high priority (e.g., data), the first interface may be used. In some cases, the network may assign different signals to different interfaces based on priority, quality of service (QOS) requirements, power saving at the network and UE 115, reported energy information at the UE 115 (e.g., energy charging rate profile, discharging/power consumption rate profile, energy state/level profile), and/or based on UE preferences and traffic (e.g., the UE may ask for certain mapping between signals and interfaces using L1/L2/L3 signaling (dedicated or piggybacked/muxed with other signals)) and the network may the assigned interface using L1/L2/L3 signaling. L3 or RRC signals may include UE assistance information (UAI).

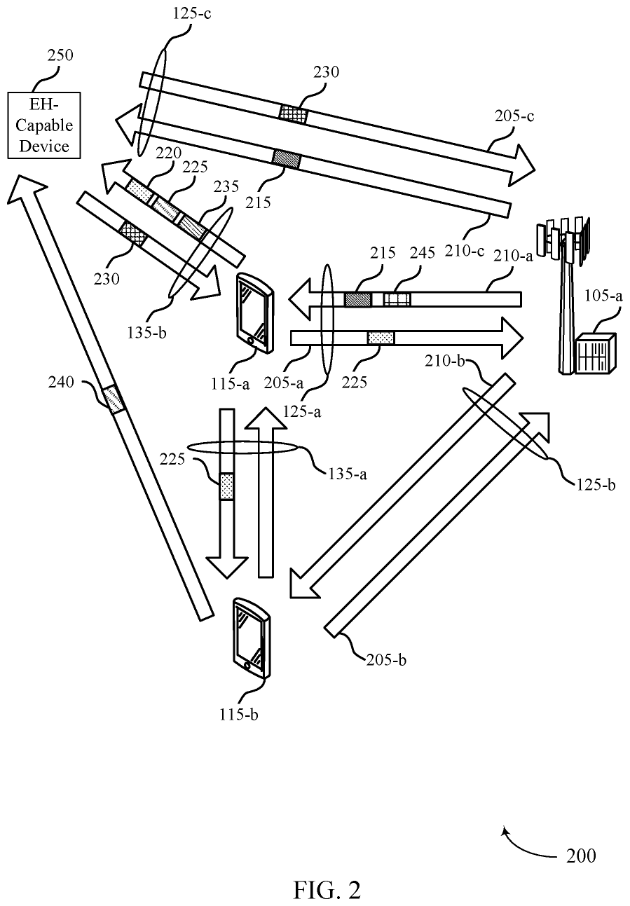

FIG. 2 shows an example of a wireless communications system 200 that supports indication of unused energy transfer or EH occasions in accordance with one or more aspects of the present disclosure. The wireless communications system 200 may implement aspects of or may be implemented by aspects of the wireless communications system 100. For example, the wireless communications system 200 includes a UE 115-a and a UE 115-b, which may be examples of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a communication link 125-a, and the UE 115-b may communicate with the network entity 105-a using a communication link 125-b. The communication link 125-a may be an example of an NR or LTE link between the UE 115-a and the network entity 105-a. The communication link 125-b may be an example of an NR or LTE link between the UE 115-b and the network entity 105-a. The communication link 125-a and the communication link 125-b may include bi-directional links that enable both uplink and downlink communications. For example, the UE 115-a may transmit uplink signals 205-a (e.g., uplink transmissions), such as uplink control signals or uplink data signals, to the network entity 105-a using the communication link 125-a and the network entity 105-a may transmit downlink signals 210-a (e.g., downlink transmissions), such as downlink control signals or downlink data signals, to the UE 115-a using the communication link 125-a. The UE 115-b may transmit uplink signals 205-b (e.g., uplink transmissions), such as uplink control signals or uplink data signals, to the network entity 105-a using the communication link 125-b and the network entity 105-a may transmit downlink signals 210-b (e.g., downlink transmissions), such as downlink control signals or downlink data signals, to the UE 115-b using the communication link 125-b.

The UE 115-a may communicate with the UE 115-b using a communication link 135-a, which may be an example of a communication link 135 as described herein. For example, the communication link 135-a may be a sidelink communication link and may support bidirectional communications between the UE 115-a and the UE 115-b.

The wireless communications system 200 may include an EH-capable device 250. In some aspects, the EH-capable device 250 may communicate with the UE 115-a via using a communication link 135-b, which may be an example of a communication link 135 as described herein. For example, the communication link 135-b may be a sidelink communication link and may support bidirectional communications between the UE 115-a and the EH-capable device 250. In some aspects, the EH-capable device 250 may communicate with the network entity 105-a using a communication link 125-c. The communication link 125-c may be an example of an NR or LTE link between the EH-capable device 250 and the network entity 105-a. The communication link 125-c may include a bi-directional link that enable both uplink and downlink communications. The EH-capable device 250 may transmit uplink signals 205-c (e.g., uplink transmissions), such as uplink control signals or uplink data signals, to the network entity 105-a using the communication link 125-c and the network entity 105-a may transmit downlink signals 210-c (e.g., downlink transmissions), such as downlink control signals or downlink data signals, to the EH-capable device 250 using the communication link 125-c.

The network entity 105-a may transmit scheduling information 215 that schedules an energy transfer transmission 220 from the UE 115-a to the EH-capable device 250. In some periods of time, the EH-capable device 250 may be unable to communicate with the serving cell (e.g., the network entity 105-a) or to perform measurements on a neighbor cell. In some cases, the EH-capable device 250 may determine to skip the scheduled energy transfer transmission 220. For example, the EH-capable device 250 may determine to skip the scheduled energy transfer transmission 220 if the EH-capable device 250 has sufficient energy, a battery level of the EH-capable device 250 exceeds a threshold level, or conditions on charging rate, discharging rate, and/or energy level are satisfied. In such cases, the EH-capable device 250 may transmit second information 230 including an indication that the EH-capable device 250 may not monitor for (e.g., may skip) the energy transfer transmission 220. Reception of the second information 230 may enable the UE 115-a to skip (e.g., cancel) the energy transfer transmission 220 and thereby save energy and resources or use those resources to beamform energy to another EH-capable device. In some aspects, reception of the second information 230 may enable the network entity 105-a to schedule the UE 115-a to skip (e.g., cancel) the energy transfer transmission 220 and thereby save energy and resources or use those resources to beamform energy to another EH-capable device. As described herein, in some aspects, the network entity 105-a may communicate with the EH-capable device 250 via the communication link 125-c (e.g., the EH-capable device 250 may be an EH-capable UE 115).

In some aspects, the UE 115-a may be unable to perform the scheduled energy transfer transmission 220, for example, due to a scheduling conflict. The UE 115-a may transmit first information 225 that includes an indication that the UE 115-a will skip the energy transfer transmission 220. In some aspects, in response to the first information 225, the network entity 105-a may schedule the UE 115-a to perform a second energy transfer transmission 235 in a second resource or set of resources. In some aspects, in response to the first information 225, the network entity 105-a may schedule a different UE (e.g., the UE 115-b) to perform a second energy transfer transmission 240 for the EH-capable device 250. In some aspects, in response to the first information 225, the network entity 105-a may use the resources for a different purpose. For example, the energy transfer transmission 220 may be scheduled to cause the EH-capable device 250 to backscatter information (e.g., the UE 115-a may be scheduled as an RF source for bi-static RFID communications where the network entity 105-a is an RFID reader), and as the UE 115-a indicates it will skip the energy transfer transmission 220, the network entity 105-a may not monitor for the backscatter signaling from the EH-capable device 250. In some aspects, in response to the first information 225, the EH-capable device 250 may use other EH techniques, such as capturing RF energy from Bluetooth, Wi-Fi, television, or laser signals, or solar or thermal energy capture. In some aspects, in response to the first information 225, the EH-capable device 250 may turn off an EH circuit to save power, as the EH circuit may consume power to perform beam tracking or signal filtering.

In some cases, the UE 115-a may be unable to perform the scheduled energy transfer transmission 220 because the UE 115-a is scheduled to serve another EH-capable device (e.g., to read or send information to another AIoT or RFID device). In some cases, the UE 115-a may be unable to perform the scheduled energy transfer transmission 220 because the UE 115-a is scheduled to communicate with other UEs (e.g., the UE 115-b) using the same or overlapping resources as the resources scheduled for the energy transfer transmission 220. In some cases, the UE 115-a may be unable to perform the scheduled energy transfer transmission 220 because the UE 115-a is scheduled to perform radio resource management (RRM), cross link interference (CLI), sensing, or positioning measurements using the same or overlapping resource as the resources scheduled for the energy transfer transmission 220. In such aspects, the UE 115-a may transmit first information 225 that includes an indication that the UE 115-a will skip the energy transfer transmission 220. The UE 115-a may transmit the first information 225 to the EH-capable device 250, the network entity 105-a, or another UE (e.g., the UE 115-b) capable of performing energy transfer transmissions for the EH-capable device 250. In some aspects, the network entity 105-a may transmit control signaling 245 that indicates a resource for the UE 115-a to transmit the first information 225 that includes the indication that the UE 115-a will skip the energy transfer transmission 220. In some aspects, the UE 115-a may determine an available resource to transmit the first information 225 that includes an indication that the UE 115-a will skip the energy transfer transmission 220.

In some aspects, the scheduling information 215 may schedule a set of energy transfer transmissions including the energy transfer transmission 220, and the first information 225 may indicate that the UE 115-a may skip one of the scheduled set of energy transfer transmissions (e.g., one EH period or cycle among a set of multiple EH periods or cycles). In some aspects, the first information 225 may indicate that the UE 115-a may skip a portion of the energy transfer transmission 220 (e.g., the UE 115-a may perform a remaining portion of the energy transfer transmission 220). For example, the energy transfer transmission 220 may be scheduled in a set of resources, and the UE 115-a may identify a conflict with a subset of resources of the set of resources. The UE 115-a may indicate in the first information 225 that the UE 115-a will skip performance of the energy transfer transmission 220 in that subset of resources. The UE 115-a may perform the energy transfer transmission 220 in the remaining resources of the set of resources. In some aspects, the UE 115-a may indicate in the first information 225 a deferral of the energy transfer transmission 220. For example, the UE 115-a may indicate that the UE 115-a will skip the energy transfer transmission 220 and will perform a second energy transfer transmission 235 in a later resource or set of resources. In some aspects, the UE 115-a may indicate that the UE 115-a will skip the energy transfer transmission 220 and may suggest a later resource or set of resources for a second energy transfer transmission 235, and the network entity 105-a may schedule the UE 115-a to perform the second energy transfer transmission 235 based on the suggested resource or set of resources.

In some aspects, the UE 115-a may indicate, in the first information 225, a list of one or more alternative UEs or network devices (e.g., including the UE 115-b) that are capable of performing energy transfer transmissions for the EH-capable device 250. In some aspects, the UE 115-a may include an indication of the positions of the alternative UEs 115 or network devices and/or best beams for receiving energy from the alternative UEs 115 or network devices. In such aspects, the network entity 105-a may use the information provided by the UE 115-a in the first information 225 to schedule an energy transmission from one of the alternative UEs 115 or network devices to the EH-capable device 250 (e.g., the second energy transfer transmission 240 from the UE 115-b).

In some aspects, the network entity 105-a may configure the UE 115-a to transmit an indication if the UE 115-a will perform the scheduled energy transfer transmission 220. The network entity 105-a may configure the UE 115-a to transmit either a “skip” or “use” indication based on which results in fewer indications and/or optimized transmission of bits.

In some aspects, the UE 115-a may transmit the first information 225 to the network entity 105-a via a Uu interface (e.g., the access interface used for communications with the network entity 105-a). In some aspects, the UE 115-a may transmit the first information 225 to the EH-capable device 250 via the Uu interface if the UE 115-a is a network unit and the EH-capable device 250 has the capability of using the Uu interface. In some aspects, the UE 115-a may transmit the first information 225 to the EH-capable device 250 via the PC5 interface (e.g., the interface used for V2X communications) if the EH-capable device 250 has the capability of using the PC5 interface. In some cases, a new interface as described herein may be used for communications between the UE 115-a and the EH-capable device.

As described herein, in some aspects, the EH-capable device 250 may transmit second information 230 including an indication that the EH-capable device 250 may not monitor for (e.g., may skip) the energy transfer transmission 220. For example, if the EH-capable device 250 has energy above a threshold, or if another scheduled higher priority signal conflicts with the energy transfer transmission 220, the EH-capable device 250 may transmit the second information 230. The EH-capable device 250 may transmit the second information 230 to the network entity 105-a and/or to the UE 115-a. EH-capable device 250 may indicate that the EH-capable device 250 will skip a portion of the energy transfer transmission. For example, the energy transfer transmission 220 may be scheduled in a set of resources, and the second information 230 may indicate that the EH-capable device 250 will skip a subset of the set of resources. In some aspects, the scheduling information 215 may schedule a set of energy transfer transmissions, and the second information 230 may indicate that the EH-capable device 250 will skip one energy transfer transmission of the set of energy transfer transmissions (e.g., one EH charging period or cycle).

In some aspects, the EH-capable device 250 may indicate a preferred or requested set of resources for a second energy transfer transmission in the second information 230. In some aspects, the EH-capable device 250 may indicate a preferred or requested set of resources for a second energy transfer transmission in the second information 230 as a deferral with respect to the resource scheduled for the energy transfer transmission 220. For example, the EH-capable device 250 may indicate an amount of the deferral. For example, the EH-capable device 250 may indicate a preferred deferral of X time units, where X may be from a configured codebook (e.g., configured via L1/L2/L3 signaling). In some aspects, multiple codebooks may be defined or configured, and one codepoint is selected to indicate a selected codebook. In some aspects, a requested deferral may be in the form of selecting a future occasion for an energy transfer transmission (e.g., for charging or powering). In some aspects, a requested deferral may be in the form of a next available time, a window of the next available time, or a set of available times or future occasions. In some aspects, in the second information 230, the EH-capable device 250 may indicate a preferred CC, band, RF source device, transmission configuration indicator (TCI) state, transmit precoding matrix indicator (TPMI), port(s), or EH harvesting configuration (e.g., power splitting for EH) to be used by the RF source, for the requested second energy transmission. Ambient devices may similarly suggest EH receive parameters.

In some aspects, the EH-capable device 250 may transmit the second information 230 if the decision to skip the energy transfer transmission 220 is against a configured default behavior. For example, by default, the EH-capable device may select EH over any other signal type. In such aspects, if the EH-capable device 250 determines to receive or transmit another signal instead of the energy transfer transmission 220 due to an approaching delay deadline, or if the EH-capable device 250 has sufficient energy, the EH-capable device 250 may transmit the second information 230.

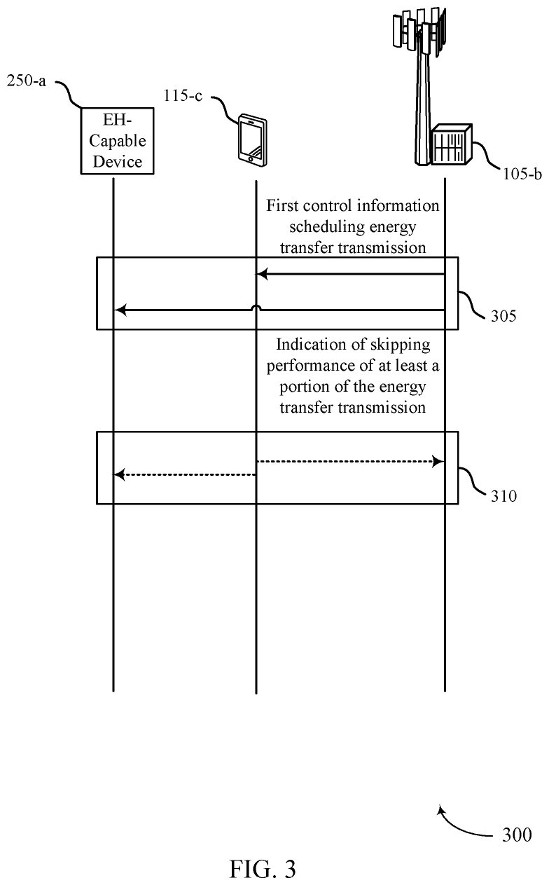

FIG. 3 shows an example of a process flow 300 that supports indication of unused energy transfer or EH occasions in accordance with one or more aspects of the present disclosure. The process flow 300 may include a UE 115-c, which may be an example of a UE 115 as described herein. The process flow 300 may also include a network entity 105-b, which may be an example of network entity 105, as described herein. The process flow 300 may also include an EH-capable device 250-a, which may be an example of an EH-capable device 250 as described herein. In the following description of the process flow 300, the operations between the network entity 105-b, the UE 115-c, and the EH-capable device 250-a may be transmitted in a different order than the example order shown, or the operations performed by between the network entity 105-b, the UE 115-c, and the EH-capable device 250-a may be performed in different orders or at different times. Some operations may also be omitted from the process flow 300, and other operations may be added to the process flow 300.

At 305, the network entity 105-b may transmit, to the UE 115-c and/or the EH-capable device 250-a, first control information that schedules an energy transfer transmission from the UE 115-c to the EH-capable device 250-a.

At 310, the UE 115-c may transmit, to one of the EH-capable device 250-a or the network entity 105-b, first information including an indication that that the UE 115-c will skip performance of at least a portion of the energy transfer transmission scheduled by the first control information. In some aspects, the UE 115-c may transmit the first information to another UE 115 or network entity 105 capable of performance of a second energy transfer transmission to the EH-capable device 250-a.

In some aspects, the network entity 105-b may transmit, to the UE 115-c, second control information indicative of a communication resource for transmission of the first information. The UE 115-c may transmit the first information using the communication resource indicated by the second control information.

In some aspects, the first control information schedules a set of multiple energy transfer transmissions from the UE 115-c to the EH-capable device 250-a, and the set of multiple energy transfer transmissions includes the energy transfer transmission. For example, the first information may indicate that the UE 115-c will skip one energy transfer transmission of the set of multiple energy transfer transmissions.

In some aspects, the first control information schedules the energy transfer transmission in a set of communication resources, and the portion is a first subset of communication resources of the set of communication resources. In some aspects, the UE 115-c may perform the energy transfer transmission via a second subset of the set of communication resources.

In some aspects, the first control information schedules the energy transfer transmission in a first set of communication resources, and the first information includes an indication of a second set of communication resources in which the UE 115-c is capable of a second energy transfer transmission from the UE 115-c to the EH-capable device 250-a.

In some aspects, the first information includes an indication of a set of UEs 115 or network entities 105 capable of energy transfer transmissions to the EH-capable device 250-a. In some aspects, the network entity 105-b may transmit, to one of the UEs 115 or network entities 105, second control information that schedules a second energy transmission from the one of the UEs 115 or network entities 105 to the EH-capable device 250-a.

In some aspects, the network entity 105-b may transmit, to the UE 115-c, second control information that schedules a second energy transfer transmission from the UE 115-c to the EH-capable device 250-a, where the second control information includes an indication for the UE 115-c to transmit second information if the UE 115-c will perform the second energy transfer transmission, where the second information indicates that the UE 115-c will transmit the second energy transfer transmission, and where the first control information includes an indication for the UE 115-c to transmit the first information if the UE 115-c will skip performance of the energy transfer transmission. The UE 115-c may transmit the second information and perform the second energy transfer transmission.

In some aspects, the EH-capable device 250-a may transmit, to the UE 115-c, second information including a first indication to skip the energy transfer transmission, and the first information is responsive to the second information. In some aspects, the EH-capable device 250-a may identify that an energy level of the EH-capable device 250-a satisfies a threshold, and the EH-capable device 250-a transmits the first information based on the identification. In some aspects, the EH-capable device 250-a may receive scheduling information for a communication, where the communication conflicts with the energy transfer transmission, and where transmitting the second information is based on the communication conflicting with the energy transfer transmission. In some aspects, the UE 115-c may perform a second energy transfer transmission a period of time after the scheduled energy transfer transmission, where the second information includes a request for performance of the second energy transfer transmission after the period of time after the scheduled energy transfer transmission. In some aspects, the second information indicates a second set of communication resources for performance of the second energy transfer transmission, the first control information schedules the energy transfer transmission in a first set of communication resources, and the second set of communication resources is subsequent to the first set of communication resources by the period of time. In some aspects, the second information indicates the period of time using a unit of time in accordance with a codebook. In some aspects, the second information indicates a CC for performance of the second energy transfer transmission after the period of time, a frequency band for performance of the second energy transfer transmission after the period of time, a TCI state for performance of the second energy transfer transmission after the period of time, a source UE or network entity to perform the second energy transfer transmission after the period of time, an EH configuration associated with the second energy transfer transmission, or a combination thereof.

In some aspects, the EH-capable device 250-a may transmit, to the network entity 105-b, second information that indicates to skip the energy transfer transmission. The network entity 105-b may transmit, to the UE 115-c in response to the second information, second control information that indicates to skip the energy transfer transmission, where the first information is responsive to the second control information.

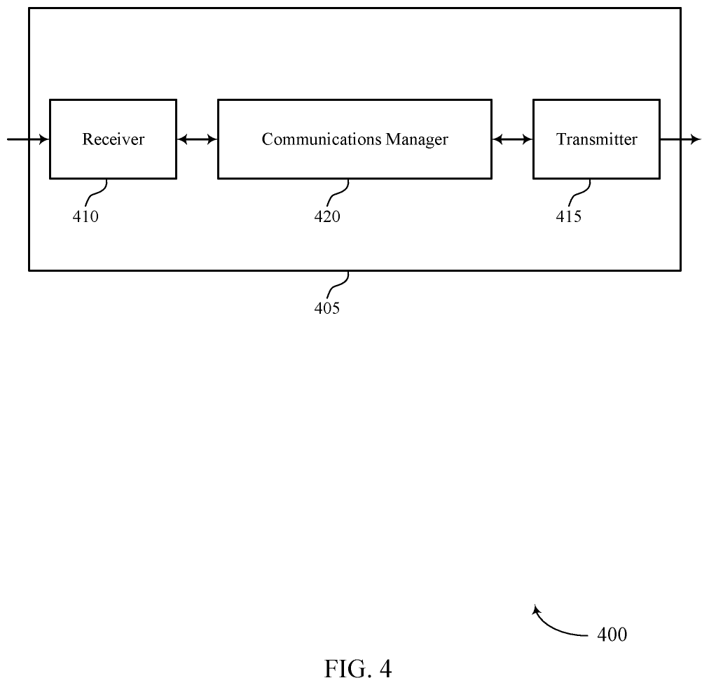

FIG. 4 shows a block diagram 400 of a device 405 that supports indication of unused energy transfer or EH occasions in accordance with one or more aspects of the present disclosure. The device 405 may be an example of aspects of a UE 115 as described herein. The device 405 may include a receiver 410, a transmitter 415, and a communications manager 420. The device 405, or one or more components of the device 405 (e.g., the receiver 410, the transmitter 415, and the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to indication of unused energy transfer or EH occasions). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to indication of unused energy transfer or EH occasions). In some aspects, the transmitter 415 may be co-located with a receiver 410 in a transceiver module. The transmitter 415 may utilize a single antenna or a set of multiple antennas.

The communications manager 420, the receiver 410, the transmitter 415, or various combinations thereof or various components thereof may be examples of means for performing various aspects of indication of unused energy transfer or EH occasions as described herein. For example, the communications manager 420, the receiver 410, the transmitter 415, or various combinations or components thereof may be capable of performing one or more of the functions described herein.

In some aspects, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor. If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

The communications manager 420 may support wireless communications in accordance with examples as disclosed herein. For example, the communications manager 420 is capable of, configured to, or operable to support a means for receiving first control information that schedules an energy transfer transmission from the first network entity to an EH-capable device. The communications manager 420 is capable of, configured to, or operable to support a means for transmitting first information including an indication that that the first network entity will skip performance of at least a portion of the energy transfer transmission scheduled by the first control information.

Additionally, or alternatively, the communications manager 420 may support wireless communications in accordance with examples as disclosed herein. For example, the communications manager 420 is capable of, configured to, or operable to support a means for receiving first control information that schedules an energy transfer transmission from a first network entity to the EH-capable device. The communications manager 420 is capable of, configured to, or operable to support a means for receiving, from the first network entity, first information including an indication that the first network entity will skip performance of at least a portion of the energy transfer transmission scheduled by the first control information.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced power consumption and more efficient utilization of communication resources.

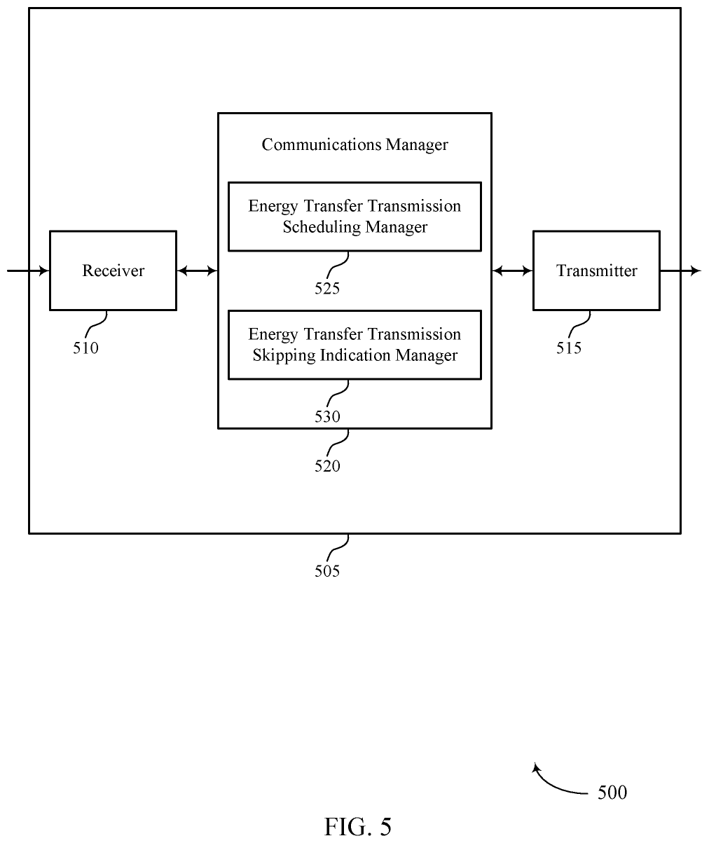

FIG. 5 shows a block diagram 500 of a device 505 that supports indication of unused energy transfer or EH occasions in accordance with one or more aspects of the present disclosure. The device 505 may be an example of aspects of a device 405 or a UE 115 as described herein. The device 505 may include a receiver 510, a transmitter 515, and a communications manager 520. The device 505, or one of more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to indication of unused energy transfer or EH occasions). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to indication of unused energy transfer or EH occasions). In some aspects, the transmitter 515 may be co-located with a receiver 510 in a transceiver module. The transmitter 515 may utilize a single antenna or a set of multiple antennas.

The device 505, or various components thereof, may be an example of means for performing various aspects of indication of unused energy transfer or EH occasions as described herein. For example, the communications manager 520 may include an energy transfer transmission scheduling manager 525 an energy transfer transmission skipping indication manager 530, or any combination thereof. The communications manager 520 may be an example of aspects of a communications manager 420 as described herein. In some aspects, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The energy transfer transmission scheduling manager 525 is capable of, configured to, or operable to support a means for receiving first control information that schedules an energy transfer transmission from the first network entity to an EH-capable device. The energy transfer transmission skipping indication manager 530 is capable of, configured to, or operable to support a means for transmitting first information including an indication that that the first network entity will skip performance of at least a portion of the energy transfer transmission scheduled by the first control information.

Additionally, or alternatively, the communications manager 520 may support wireless communications in accordance with examples as disclosed herein. The energy transfer transmission scheduling manager 525 is capable of, configured to, or operable to support a means for receiving first control information that schedules an energy transfer transmission from a first network entity to the EH-capable device. The energy transfer transmission skipping indication manager 530 is capable of, configured to, or operable to support a means for receiving, from the first network entity, first information including an indication that the first network entity will skip performance of at least a portion of the energy transfer transmission scheduled by the first control information.

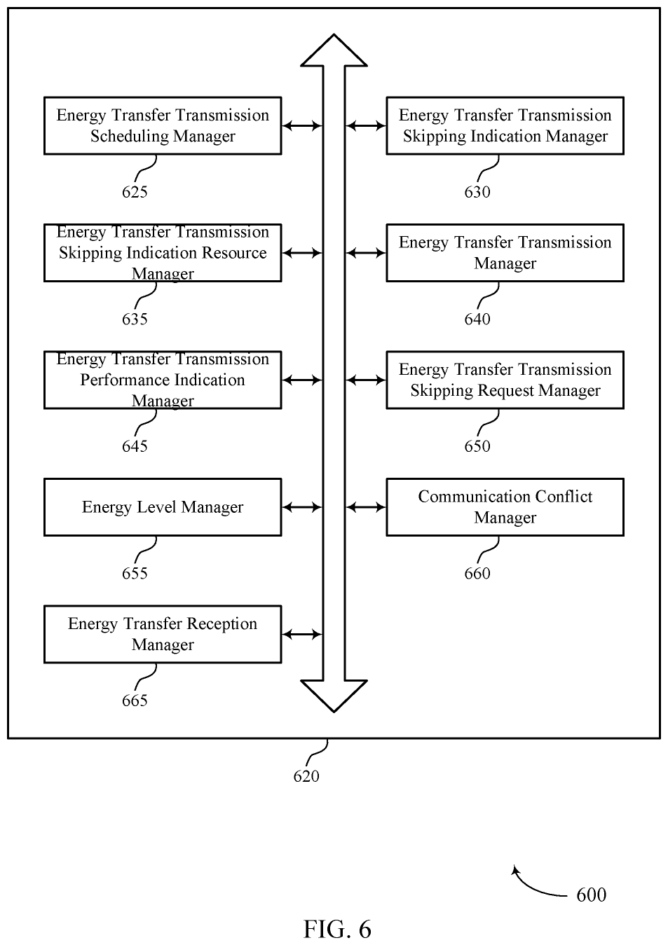

FIG. 6 shows a block diagram 600 of a communications manager 620 that supports indication of unused energy transfer or EH occasions in accordance with one or more aspects of the present disclosure. The communications manager 620 may be an example of aspects of a communications manager 420, a communications manager 520, or both, as described herein. The communications manager 620, or various components thereof, may be an example of means for performing various aspects of indication of unused energy transfer or EH occasions as described herein. For example, the communications manager 620 may include an energy transfer transmission scheduling manager 625, an energy transfer transmission skipping indication manager 630, an energy transfer transmission skipping indication resource manager 635, an energy transfer transmission manager 640, an energy transfer transmission performance indication manager 645, an energy transfer transmission skipping request manager 650, an energy level manager 655, a communication conflict manager 660, an energy transfer reception manager 665, or any combination thereof. Each of these components, or components or subcomponents thereof (e.g., one or more processors, one or more memories), may communicate, directly or indirectly, with one another (e.g., via one or more buses).

The communications manager 620 may support wireless communications in accordance with examples as disclosed herein. The energy transfer transmission scheduling manager 625 is capable of, configured to, or operable to support a means for receiving first control information that schedules an energy transfer transmission from the first network entity to an EH-capable device. The energy transfer transmission skipping indication manager 630 is capable of, configured to, or operable to support a means for transmitting first information including an indication that that the first network entity will skip performance of at least a portion of the energy transfer transmission scheduled by the first control information.

In some aspects, the energy transfer transmission skipping indication resource manager 635 is capable of, configured to, or operable to support a means for receiving second control information indicative of a communication resource for transmission of the first information.

In some aspects, the first control information schedules a set of multiple energy transfer transmissions from the first network entity to the EH-capable device. In some aspects, the set of multiple energy transfer transmissions includes the energy transfer transmission.

In some aspects, the first control information schedules the energy transfer transmission in a set of communication resources. In some aspects, the portion is a first subset of communication resources of the set of communication resources.

In some aspects, the energy transfer transmission manager 640 is capable of, configured to, or operable to support a means for performing the energy transfer transmission via a second subset of the set of communication resources.

In some aspects, the first control information schedules the energy transfer transmission in a first set of communication resources. In some aspects, the first information includes an indication of a second set of communication resources in which the first network entity is capable of a second energy transfer transmission from the first network entity to the EH-capable device.

In some aspects, the first information includes an indication of a set of network entities capable of energy transfer transmissions to the EH-capable device.

In some aspects, the energy transfer transmission scheduling manager 625 is capable of, configured to, or operable to support a means for receiving second control information that schedules a second energy transfer transmission from the first network entity to the EH-capable device, where the second control information includes an indication for the first network entity to transmit second information if the first network entity will perform the second energy transfer transmission, where the second information indicates that the first network entity will transmit the second energy transfer transmission, and where the first control information includes an indication for the first network entity to transmit the first information if the first network entity will skip performance of the energy transfer transmission. In some aspects, the energy transfer transmission performance indication manager 645 is capable of, configured to, or operable to support a means for transmitting the second information. In some aspects, the energy transfer transmission manager 640 is capable of, configured to, or operable to support a means for performing the second energy transfer transmission.

In some aspects, the energy transfer transmission skipping request manager 650 is capable of, configured to, or operable to support a means for receiving, from the EH-capable device, second information including a first indication to skip performance of the energy transfer transmission, where transmitting the first information is based on the second information.

In some aspects, the energy transfer transmission manager 640 is capable of, configured to, or operable to support a means for performing a second energy transfer transmission a period of time after the scheduled energy transfer transmission, where the second information includes a request for performance of the second energy transfer transmission after the period of time after the scheduled energy transfer transmission.

In some aspects, the second information indicates a second set of communication resources for performance of the second energy transfer transmission. In some aspects, the first control information schedules the energy transfer transmission in a first set of communication resources. In some aspects, the second set of communication resources is subsequent to the first set of communication resources by the period of time.

In some aspects, the second information indicates the period of time using a unit of time in accordance with a codebook.

In some aspects, the second information indicates a CC for performance of the second energy transfer transmission after the period of time, a frequency band for performance of the second energy transfer transmission after the period of time, a TCI state for performance of the second energy transfer transmission after the period of time, a source network entity to perform the second energy transfer transmission after the period of time, an EH configuration associated with the second energy transfer transmission, or a combination thereof.

In some aspects, to support transmitting the first information, the energy transfer transmission skipping indication manager 630 is capable of, configured to, or operable to support a means for transmitting the first information to the EH-capable device, a second network entity from which the first network entity received the first control information, or a third network entity capable of performance of a second energy transfer transmission to the EH-capable device.

Additionally, or alternatively, the communications manager 620 may support wireless communications in accordance with examples as disclosed herein. In some aspects, the energy transfer transmission scheduling manager 625 is capable of, configured to, or operable to support a means for receiving first control information that schedules an energy transfer transmission from a first network entity to the EH-capable device. In some aspects, the energy transfer transmission skipping indication manager 630 is capable of, configured to, or operable to support a means for receiving, from the first network entity, first information including an indication that the first network entity will skip performance of at least a portion of the energy transfer transmission scheduled by the first control information.

In some aspects, the energy transfer transmission skipping request manager 650 is capable of, configured to, or operable to support a means for transmitting, to the first network entity, second information including a first indication to skip the energy transfer transmission, where the first information is responsive to the second information.

In some aspects, the energy level manager 655 is capable of, configured to, or operable to support a means for identifying that an energy level of the EH-capable device satisfies a threshold, where transmitting the second information is based on the identification.

In some aspects, the communication conflict manager 660 is capable of, configured to, or operable to support a means for receiving scheduling information for a communication, where the communication conflicts with the energy transfer transmission, and where transmitting the second information is based on the communication conflicting with the energy transfer transmission, the second information.

In some aspects, the energy transfer reception manager 665 is capable of, configured to, or operable to support a means for receiving a second energy transfer transmission after a period of time after the scheduled energy transfer transmission, where the second information includes a request for performance of the second energy transfer transmission after the period of time after the scheduled energy transfer transmission.

In some aspects, the second information includes an indication of a second set of communication resources for performance of the second energy transfer transmission. In some aspects, the first control information schedules the energy transfer transmission in a first set of communication resources. In some aspects, the second set of communication resources is subsequent to the first set of communication resources by the period of time.

In some aspects, the second information indicates the period of time using a unit of time in accordance with a codebook.

In some aspects, the second information includes an indication of a CC for performance of the second energy transfer transmission after the period of time, a frequency band for performance of the second energy transfer transmission after the period of time, a TCI state for performance of the second energy transfer transmission after the period of time, a source network entity to perform the second energy transfer transmission after the period of time, an EH configuration associated with the second energy transfer transmission, or a combination thereof.

In some aspects, the first control information schedules a set of multiple energy transfer transmissions from the first network entity to the EH-capable device. In some aspects, the set of multiple energy transfer transmissions includes the energy transfer transmission.

In some aspects, the first control information schedules the energy transfer transmission in a set of communication resources. In some aspects, the portion is a first subset of communication resources of the set of communication resources.

In some aspects, the energy transfer reception manager 665 is capable of, configured to, or operable to support a means for receiving the energy transfer transmission via a second subset of the set of communication resources.

In some aspects, the first control information schedules the energy transfer transmission in a first set of communication resources. In some aspects, the first information includes an indication of a second set of communication resources in which the first network entity is capable of performance of a second energy transfer transmission from the first network entity to the EH-capable device.

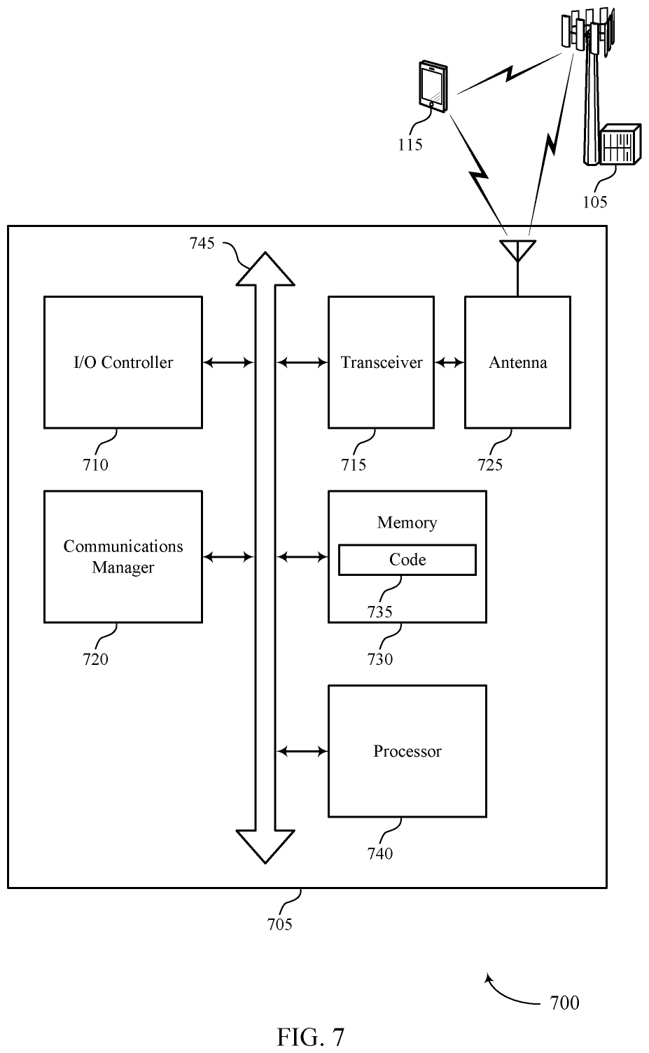

FIG. 7 shows a diagram of a system 700 including a device 705 that supports indication of unused energy transfer or EH occasions in accordance with one or more aspects of the present disclosure. The device 705 may be an example of or include the components of a device 405, a device 505, or a UE 115 as described herein. The device 705 may communicate (e.g., wirelessly) with one or more network entities 105, one or more UEs 115, or any combination thereof. The device 705 may include components for bi-directional voice and data communications including components for transmitting and receiving communications, such as a communications manager 720, an input/output (I/O) controller 710, a transceiver 715, an antenna 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna 725. However, in some other cases, the device 705 may have more than one antenna 725, which may be capable of concurrently transmitting or receiving multiple wireless transmissions. The transceiver 715 may communicate bi-directionally, via the one or more antennas 725, wired, or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable code 735 including instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may contain, among other things, a basic I/O system (BIOS) which may control basic hardware or software operation such as the interaction with peripheral components or devices.

The at least one processor 740 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting indication of unused energy transfer or EH occasions). For example, the device 705 or a component of the device 705 may include at least one processor 740 and at least one memory 730 coupled with or to the at least one processor 740, the at least one processor 740 and at least one memory 730 configured to perform various functions described herein. In some aspects, the at least one processor 740 may include multiple processors and the at least one memory 730 may include multiple memories. One or more of the multiple processors may be coupled with one or more of the multiple memories, which may, individually or collectively, be configured to perform various functions herein.

The communications manager 720 may support wireless communications in accordance with examples as disclosed herein. For example, the communications manager 720 is capable of, configured to, or operable to support a means for receiving first control information that schedules an energy transfer transmission from the first network entity to an EH-capable device. The communications manager 720 is capable of, configured to, or operable to support a means for transmitting first information including an indication that that the first network entity will skip performance of at least a portion of the energy transfer transmission scheduled by the first control information.

Additionally, or alternatively, the communications manager 720 may support wireless communications in accordance with examples as disclosed herein. For example, the communications manager 720 is capable of, configured to, or operable to support a means for receiving first control information that schedules an energy transfer transmission from a first network entity to the EH-capable device. The communications manager 720 is capable of, configured to, or operable to support a means for receiving, from the first network entity, first information including an indication that the first network entity will skip performance of at least a portion of the energy transfer transmission scheduled by the first control information.

By including or configuring the communications manager 720 in accordance with examples as described herein, the device 705 may support techniques for reduced power consumption, more efficient utilization of communication resources, improved coordination between devices, and longer battery life.

In some aspects, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some aspects, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of indication of unused energy transfer or EH occasions as described herein, or the at least one processor 740 and the at least one memory 730 may be otherwise configured to, individually or collectively, perform or support such operations.

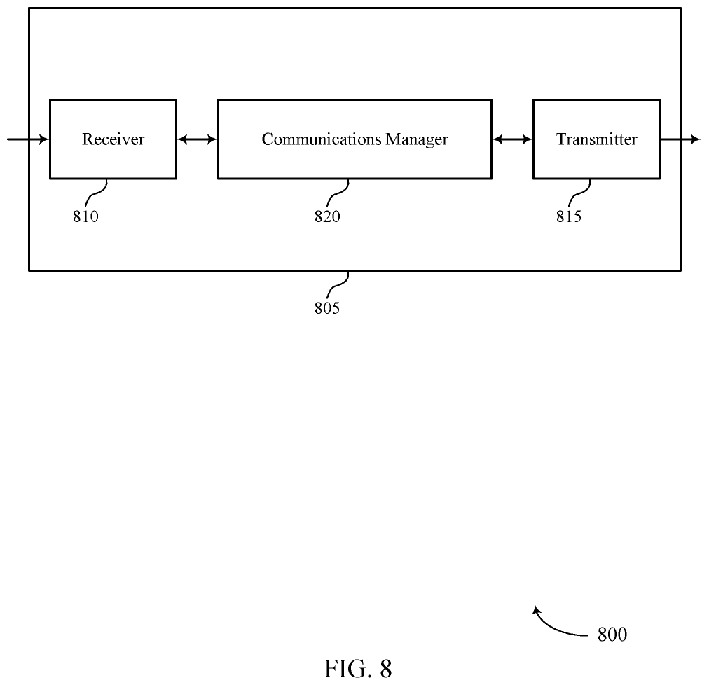

FIG. 8 shows a block diagram 800 of a device 805 that supports indication of unused energy transfer or EH occasions in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some aspects, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some aspects, the transmitter 815 and the receiver 810 may be co-located in a transceiver, which may include or be coupled with a modem.

The communications manager 820, the receiver 810, the transmitter 815, or various combinations thereof or various components thereof may be examples of means for performing various aspects of indication of unused energy transfer or EH occasions as described herein. For example, the communications manager 820, the receiver 810, the transmitter 815, or various combinations or components thereof may be capable of performing one or more of the functions described herein.

In some aspects, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some aspects, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor. If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some aspects, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for transmitting, to a second network entity, first control information that schedules an energy transfer transmission from the second network entity to an EH-capable device. The communications manager 820 is capable of, configured to, or operable to support a means for receiving, from the second network entity, first information including an indication that the second network entity will skip performance of at least a portion of the energy transfer transmission scheduled by the first control information.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced power consumption and more efficient utilization of communication resources.

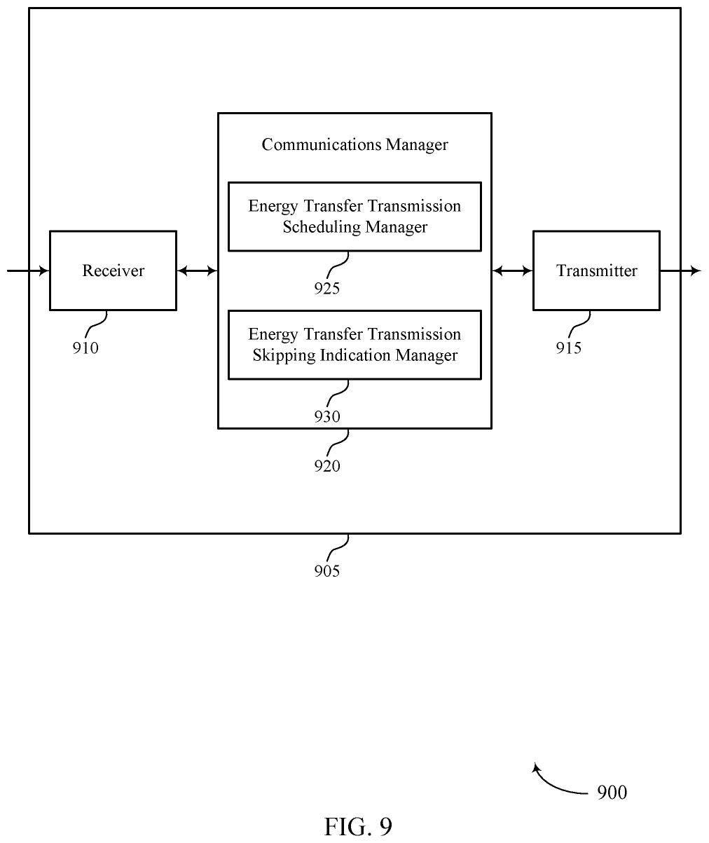

FIG. 9 shows a block diagram 900 of a device 905 that supports indication of unused energy transfer or EH occasions in accordance with one or more aspects of the present disclosure. The device 905 may be an example of aspects of a device 805 or a network entity 105 as described herein. The device 905 may include a receiver 910, a transmitter 915, and a communications manager 920. The device 905, or one of more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some aspects, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some aspects, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some aspects, the transmitter 915 and the receiver 910 may be co-located in a transceiver, which may include or be coupled with a modem.

The device 905, or various components thereof, may be an example of means for performing various aspects of indication of unused energy transfer or EH occasions as described herein. For example, the communications manager 920 may include an energy transfer transmission scheduling manager 925 an energy transfer transmission skipping indication manager 930, or any combination thereof. The communications manager 920 may be an example of aspects of a communications manager 820 as described herein. In some aspects, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The energy transfer transmission scheduling manager 925 is capable of, configured to, or operable to support a means for transmitting, to a second network entity, first control information that schedules an energy transfer transmission from the second network entity to an EH-capable device. The energy transfer transmission skipping indication manager 930 is capable of, configured to, or operable to support a means for receiving, from the second network entity, first information including an indication that the second network entity will skip performance of at least a portion of the energy transfer transmission scheduled by the first control information.

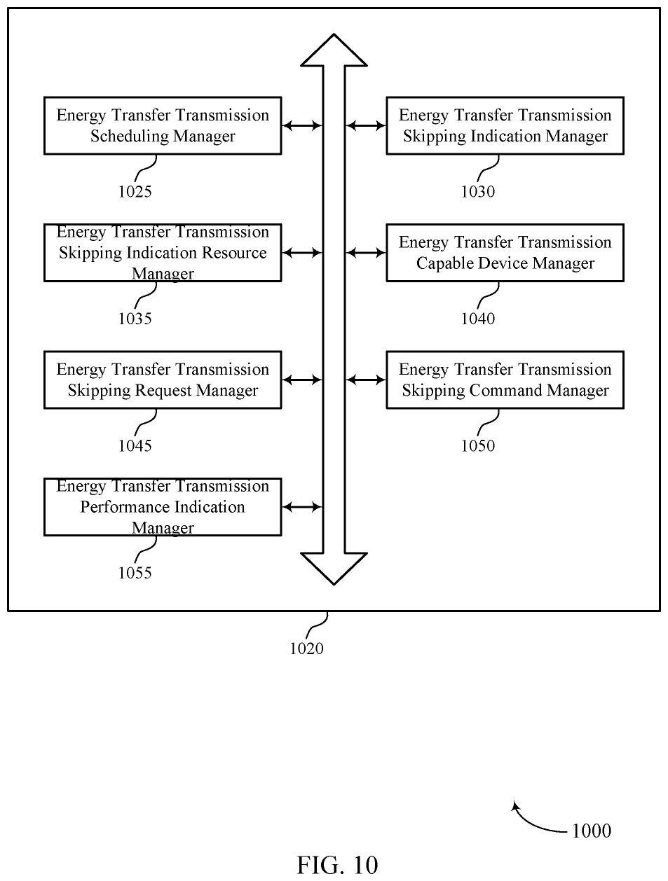

FIG. 10 shows a block diagram 1000 of a communications manager 1020 that supports indication of unused energy transfer or EH occasions in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of indication of unused energy transfer or EH occasions as described herein. For example, the communications manager 1020 may include an energy transfer transmission scheduling manager 1025, an energy transfer transmission skipping indication manager 1030, an energy transfer transmission skipping indication resource manager 1035, an energy transfer transmission capable device manager 1040, an energy transfer transmission skipping request manager 1045, an energy transfer transmission skipping command manager 1050, an energy transfer transmission performance indication manager 1055, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The energy transfer transmission scheduling manager 1025 is capable of, configured to, or operable to support a means for transmitting, to a second network entity, first control information that schedules an energy transfer transmission from the second network entity to an EH-capable device. The energy transfer transmission skipping indication manager 1030 is capable of, configured to, or operable to support a means for receiving, from the second network entity, first information including an indication that the second network entity will skip performance of at least a portion of the energy transfer transmission scheduled by the first control information.

In some aspects, the energy transfer transmission skipping indication resource manager 1035 is capable of, configured to, or operable to support a means for transmitting, to the second network entity, second control information indicative of a communication resource for transmission of the first information, where the first information is received via the communication resource.

In some aspects, the first control information schedules a set of multiple energy transfer transmissions from the second network entity to the EH-capable device. In some aspects, the set of multiple energy transfer transmissions includes the energy transfer transmission.

In some aspects, the first control information schedules the energy transfer transmission in a set of communication resources. In some aspects, the portion is a first subset of communication resources of the set of communication resources.

In some aspects, the energy transfer transmission scheduling manager 1025 is capable of, configured to, or operable to support a means for transmitting second control information that schedules a second energy transfer transmission from the second network entity to the EH-capable device in a second set of communication resources, where the first control information schedules the energy transfer transmission in a first set of communication resources, where the first information indicates the second set of communication resources in which the second network entity is capable of performance of the second energy transfer transmission from the second network entity to the EH-capable device.

In some aspects, the energy transfer transmission capable device manager 1040 is capable of, configured to, or operable to support a means for receiving, from the second network entity, an indication of a set of network entities capable of performance of energy transfer transmissions to the EH-capable device. In some aspects, the energy transfer transmission scheduling manager 1025 is capable of, configured to, or operable to support a means for transmitting, to one of the set of network entities, second control information that schedules a second energy transmission from the one of the set of network entities to the EH-capable device.

In some aspects, the energy transfer transmission skipping request manager 1045 is capable of, configured to, or operable to support a means for receiving, from the EH-capable device, second information that indicates to skip the energy transfer transmission. In some aspects, the energy transfer transmission skipping command manager 1050 is capable of, configured to, or operable to support a means for transmitting, to the second network entity in response to the second information, second control information that indicates to skip the energy transfer transmission, where the first information is responsive to the second control information.

In some aspects, the energy transfer transmission scheduling manager 1025 is capable of, configured to, or operable to support a means for transmitting, to the second network entity, second control information that schedules a second energy transfer transmission from the second network entity to the EH-capable device, where the second control information includes an indication for the second network entity to transmit second information if the second network entity will perform the second energy transfer transmission, where the second information indicates that the second network entity will transmit the second energy transfer transmission, and where the first control information includes an indication for the second network entity to transmit the first information if the second network entity will skip performance of the energy transfer transmission. In some aspects, the energy transfer transmission performance indication manager 1055 is capable of, configured to, or operable to support a means for receiving, from the second network entity, the second information that indicates the second network entity will perform the second energy transfer transmission.

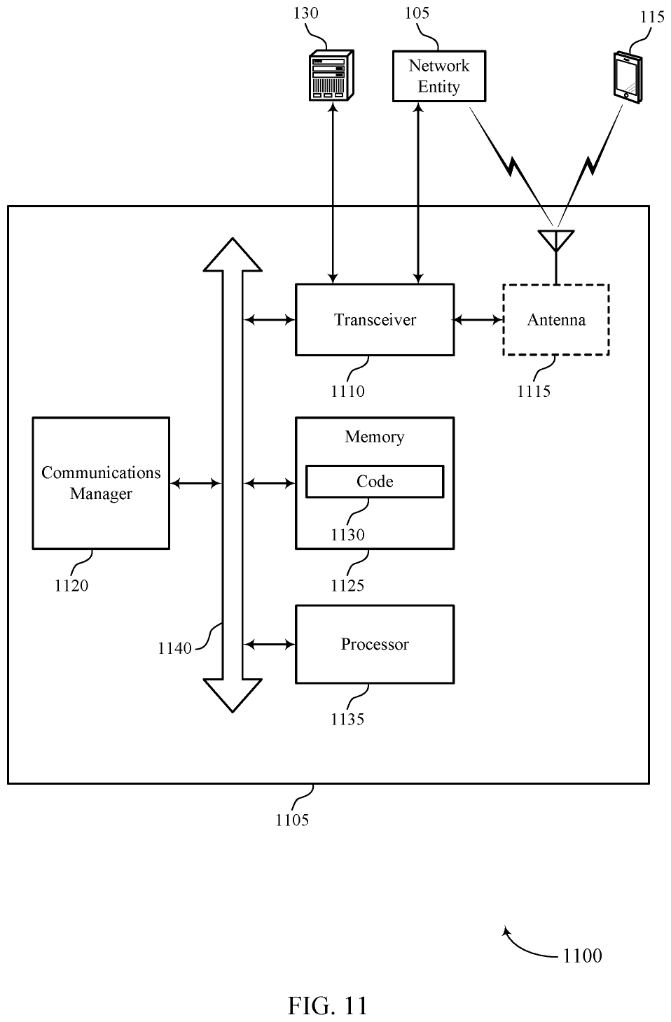

FIG. 11 shows a diagram of a system 1100 including a device 1105 that supports indication of unused energy transfer or EH occasions in accordance with one or more aspects of the present disclosure. The device 1105 may be an example of or include the components of a device 805, a device 905, or a network entity 105 as described herein. The device 1105 may communicate with one or more network entities 105, one or more UEs 115, or any combination thereof, which may include communications over one or more wired interfaces, over one or more wireless interfaces, or any combination thereof. The device 1105 may include components that support outputting and obtaining communications, such as a communications manager 1120, a transceiver 1110, an antenna 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some aspects, the transceiver 1110 may include a wired transceiver and may communicate bi-directionally with another wired transceiver. Additionally, or alternatively, in some aspects, the transceiver 1110 may include a wireless transceiver and may communicate bi-directionally with another wireless transceiver. In some aspects, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some aspects, the transceiver 1110 may be operable to support communications via one or more communications links (e.g., a communication link 125, a backhaul communication link 120, a midhaul communication link 162, a fronthaul communication link 168).

The at least one memory 1125 may include RAM, ROM, or any combination thereof. The at least one memory 1125 may store computer-readable, computer-executable code 1130 including instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may contain, among other things, a BIOS which may control basic hardware or software operation such as the interaction with peripheral components or devices. In some aspects, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting indication of unused energy transfer or EH occasions). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125). In some implementations, the at least one processor 1135 may be a component of a processing system. A processing system may generally refer to a system or series of machines or components that receives inputs and processes the inputs to produce a set of outputs (which may be passed to other systems or components of, for example, the device 1105). For example, a processing system of the device 1105 may refer to a system including the various other components or subcomponents of the device 1105, such as the at least one processor 1135, or the transceiver 1110, or the communications manager 1120, or other components or combinations of components of the device 1105. The processing system of the device 1105 may interface with other components of the device 1105, and may process information received from other components (such as inputs or signals) or output information to other components. For example, a chip or modem of the device 1105 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1105 may transmit information output from the chip or modem. Additionally, or alternatively, in some implementations, the one or more interfaces may refer to an interface between the processing system of the chip or modem and a receiver, such that the device 1105 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1140 may support communications of (e.g., within) a protocol layer of a protocol stack. In some aspects, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some aspects, the communications manager 1120 may manage aspects of communications with a core network 130 (e.g., via one or more wired or wireless backhaul links). For example, the communications manager 1120 may manage the transfer of data communications for client devices, such as one or more UEs 115. In some aspects, the communications manager 1120 may manage communications with other network entities 105, and may include a controller or scheduler for controlling communications with UEs 115 in cooperation with other network entities 105. In some aspects, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for transmitting, to a second network entity, first control information that schedules an energy transfer transmission from the second network entity to an EH-capable device. The communications manager 1120 is capable of, configured to, or operable to support a means for receiving, from the second network entity, first information including an indication that the second network entity will skip performance of at least a portion of the energy transfer transmission scheduled by the first control information.

By including or configuring the communications manager 1120 in accordance with examples as described herein, the device 1105 may support techniques for reduced power consumption, more efficient utilization of communication resources, and improved coordination between devices.

In some aspects, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some aspects, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of indication of unused energy transfer or EH occasions as described herein, or the at least one processor 1135 and the at least one memory 1125 may be otherwise configured to, individually or collectively, perform or support such operations.

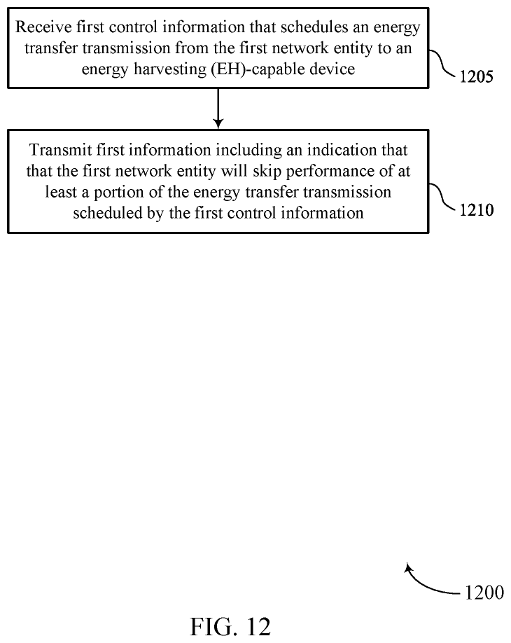

FIG. 12 shows a flowchart illustrating a method 1200 that supports indication of unused energy transfer or EH occasions in accordance with aspects of the present disclosure. The operations of the method 1200 may be implemented by a UE or its components as described herein. For example, the operations of the method 1200 may be performed by a UE 115 as described with reference to FIGS. 1 through 7. In some aspects, a UE may execute a set of instructions to control the functional elements of the UE to perform the described functions. Additionally, or alternatively, the UE may perform aspects of the described functions using special-purpose hardware.

At 1205, the method may include receiving first control information that schedules an energy transfer transmission from the first network entity to an EH-capable device. The operations of block 1205 may be performed in accordance with examples as disclosed herein. In some aspects, aspects of the operations of 1205 may be performed by an energy transfer transmission scheduling manager 625 as described with reference to FIG. 6.

At 1210, the method may include transmitting first information including an indication that that the first network entity will skip performance of at least a portion of the energy transfer transmission scheduled by the first control information. The operations of block 1210 may be performed in accordance with examples as disclosed herein. In some aspects, aspects of the operations of 1210 may be performed by an energy transfer transmission skipping indication manager 630 as described with reference to FIG. 6.

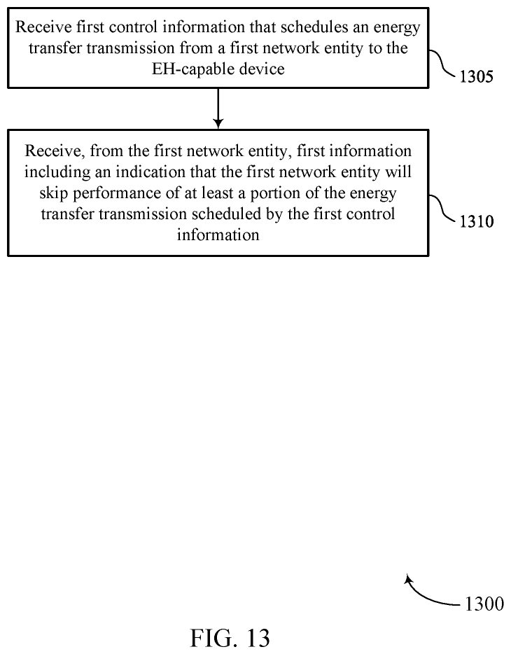

FIG. 13 shows a flowchart illustrating a method 1300 that supports indication of unused energy transfer or EH occasions in accordance with aspects of the present disclosure. The operations of the method 1300 may be implemented by a UE or its components as described herein. For example, the operations of the method 1300 may be performed by a UE 115 as described with reference to FIGS. 1 through 7. In some aspects, a UE may execute a set of instructions to control the functional elements of the UE to perform the described functions. Additionally, or alternatively, the UE may perform aspects of the described functions using special-purpose hardware.

At 1305, the method may include receiving first control information that schedules an energy transfer transmission from a first network entity to the EH-capable device. The operations of block 1305 may be performed in accordance with examples as disclosed herein. In some aspects, aspects of the operations of 1305 may be performed by an energy transfer transmission scheduling manager 625 as described with reference to FIG. 6.

At 1310, the method may include receiving, from the first network entity, first information including an indication that the first network entity will skip performance of at least a portion of the energy transfer transmission scheduled by the first control information. The operations of block 1310 may be performed in accordance with examples as disclosed herein. In some aspects, aspects of the operations of 1310 may be performed by an energy transfer transmission skipping indication manager 630 as described with reference to FIG. 6.

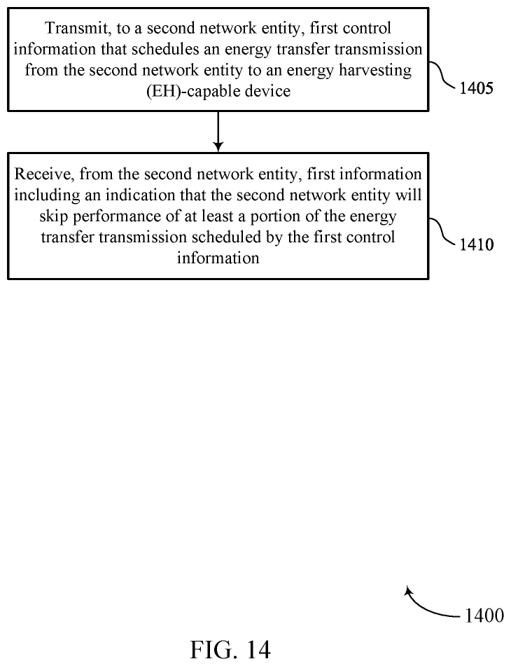

FIG. 14 shows a flowchart illustrating a method 1400 that supports indication of unused energy transfer or EH occasions in accordance with aspects of the present disclosure. The operations of the method 1400 may be implemented by a network entity or its components as described herein. For example, the operations of the method 1400 may be performed by a network entity as described with reference to FIGS. 1 through 3 and 8 through 11. In some aspects, a network entity may execute a set of instructions to control the functional elements of the network entity to perform the described functions. Additionally, or alternatively, the network entity may perform aspects of the described functions using special-purpose hardware.

At 1405, the method may include transmitting, to a second network entity, first control information that schedules an energy transfer transmission from the second network entity to an EH-capable device. The operations of block 1405 may be performed in accordance with examples as disclosed herein. In some aspects, aspects of the operations of 1405 may be performed by an energy transfer transmission scheduling manager 1025 as described with reference to FIG. 10.

At 1410, the method may include receiving, from the second network entity, first information including an indication that the second network entity will skip performance of at least a portion of the energy transfer transmission scheduled by the first control information. The operations of block 1410 may be performed in accordance with examples as disclosed herein. In some aspects, aspects of the operations of 1410 may be performed by an energy transfer transmission skipping indication manager 1030 as described with reference to FIG. 10.

The following provides an overview of aspects of the present disclosure:

Aspect 1: A method for wireless communications at a first network entity, comprising: receiving first control information that schedules an energy transfer transmission from the first network entity to an EH-capable device; and transmitting first information including an indication that that the first network entity will skip performance of at least a portion of the energy transfer transmission scheduled by the first control information.

Aspect 2: The method of aspect 1, further comprising: receiving second control information indicative of a communication resource for transmission of the first information.

Aspect 3: The method of any of aspects 1 through 2, wherein the first control information schedules a plurality of energy transfer transmissions from the first network entity to the EH-capable device, the plurality of energy transfer transmissions includes the energy transfer transmission.

Aspect 4: The method of any of aspects 1 through 3, wherein the first control information schedules the energy transfer transmission in a set of communication resources, and the portion is a first subset of communication resources of the set of communication resources.

Aspect 5: The method of aspect 4, further comprising: performing the energy transfer transmission via a second subset of the set of communication resources.

Aspect 6: The method of any of aspects 1 through 5, wherein the first control information schedules the energy transfer transmission in a first set of communication resources, and the first information includes an indication of a second set of communication resources in which the first network entity is capable of a second energy transfer transmission from the first network entity to the EH-capable device.

Aspect 7: The method of any of aspects 1 through 6, wherein the first information includes an indication of a set of network entities capable of energy transfer transmissions to the EH-capable device.

Aspect 8: The method of any of aspects 1 through 7, further comprising: receiving second control information that schedules a second energy transfer transmission from the first network entity to the EH-capable device, wherein the second control information includes an indication for the first network entity to transmit second information if the first network entity will perform the second energy transfer transmission, wherein the second information indicates that the first network entity will transmit the second energy transfer transmission, and wherein the first control information includes an indication for the first network entity to transmit the first information if the first network entity will skip performance of the energy transfer transmission; transmitting the second information; and performing the second energy transfer transmission.

Aspect 9: The method of any of aspects 1 through 4 or 6 through 8, further comprising: receiving, from the EH-capable device, second information including a first indication to skip performance of the energy transfer transmission, wherein transmitting the first information is based on the second information.

Aspect 10: The method of aspect 9, further comprising: performing a second energy transfer transmission a period of time after the scheduled energy transfer transmission, wherein the second information includes a request for performance of the second energy transfer transmission after the period of time after the scheduled energy transfer transmission.

Aspect 11: The method of aspect 10, wherein the second information indicates a second set of communication resources for performance of the second energy transfer transmission, the first control information schedules the energy transfer transmission in a first set of communication resources, and the second set of communication resources is subsequent to the first set of communication resources by the period of time.

Aspect 12: The method of any of aspects 10 through 11, wherein the second information indicates the period of time using a unit of time in accordance with a codebook.

Aspect 13: The method of any of aspects 10 through 12, wherein the second information indicates a CC for performance of the second energy transfer transmission after the period of time, a frequency band for performance of the second energy transfer transmission after the period of time, a TCI state for performance of the second energy transfer transmission after the period of time, a source network entity to perform the second energy transfer transmission after the period of time, an EH configuration associated with the second energy transfer transmission, or a combination thereof.

Aspect 14: The method of any of aspects 1 through 13, wherein transmitting the first information comprises: transmitting the first information to the EH-capable device, a second network entity from which the first network entity received the first control information, or a third network entity capable of performance of a second energy transfer transmission to the EH-capable device.

Aspect 15: A method for wireless communications at an EH-capable device, comprising: receiving first control information that schedules an energy transfer transmission from a first network entity to the EH-capable device; and receiving, from the first network entity, first information including an indication that the first network entity will skip performance of at least a portion of the energy transfer transmission scheduled by the first control information.

Aspect 16: The method of aspect 15, further comprising: transmitting, to the first network entity, second information including a first indication to skip the energy transfer transmission, wherein the first information is responsive to the second information.

Aspect 17: The method of aspect 16, further comprising: identifying that an energy level of the EH-capable device satisfies a threshold, wherein transmitting the second information is based on the identification.

Aspect 18: The method of any of aspects 16 through 17, further comprising: receiving scheduling information for a communication, wherein the communication conflicts with the energy transfer transmission, and wherein transmitting the second information is based on the communication conflicting with the energy transfer transmission.

Aspect 19: The method of any of aspects 16 through 18, further comprising: receiving a second energy transfer transmission after a period of time after the scheduled energy transfer transmission, wherein the second information includes a request for performance of the second energy transfer transmission after the period of time after the scheduled energy transfer transmission.

Aspect 20: The method of aspect 19, wherein the second information includes an indication of a second set of communication resources for performance of the second energy transfer transmission, the first control information schedules the energy transfer transmission in a first set of communication resources, and the second set of communication resources is subsequent to the first set of communication resources by the period of time.

Aspect 21: The method of any of aspects 19 through 20, wherein the second information indicates the period of time using a unit of time in accordance with a codebook.

Aspect 22: The method of any of aspects 19 through 21, wherein the second information includes an indication of a CC for performance of the second energy transfer transmission after the period of time, a frequency band for performance of the second energy transfer transmission after the period of time, a TCI state for performance of the second energy transfer transmission after the period of time, a source network entity to perform the second energy transfer transmission after the period of time, an energy harvesting configuration associated with the second energy transfer transmission, or a combination thereof.

Aspect 23: The method of any of aspects 15 through 22, wherein the first control information schedules a plurality of energy transfer transmissions from the first network entity to the EH-capable device, the plurality of energy transfer transmissions includes the energy transfer transmission.

Aspect 24: The method of any of aspects 15 through 23, wherein the first control information schedules the energy transfer transmission in a set of communication resources, and the portion is a first subset of communication resources of the set of communication resources.

Aspect 25: The method of aspect 24, further comprising: receiving the energy transfer transmission via a second subset of the set of communication resources.

Aspect 26: The method of any of aspects 15 through 25, wherein the first control information schedules the energy transfer transmission in a first set of communication resources, the first information includes an indication of a second set of communication resources in which the first network entity is capable of performance of a second energy transfer transmission from the first network entity to the EH-capable device.

Aspect 27: A method for wireless communications at a first network entity, comprising: transmitting, to a second network entity, first control information that schedules an energy transfer transmission from the second network entity to an EH-capable device; and receiving, from the second network entity, first information including an indication that the second network entity will skip performance of at least a portion of the energy transfer transmission scheduled by the first control information.

Aspect 28: The method of aspect 27, further comprising: transmitting, to the second network entity, second control information indicative of a communication resource for transmission of the first information, wherein the first information is received via the communication resource.

Aspect 29: The method of any of aspects 27 through 28, wherein the first control information schedules a plurality of energy transfer transmissions from the second network entity to the EH-capable device, the plurality of energy transfer transmissions includes the energy transfer transmission.

Aspect 30: The method of any of aspects 27 through 29, wherein the first control information schedules the energy transfer transmission in a set of communication resources, the portion is a first subset of communication resources of the set of communication resources.

Aspect 31: The method of any of aspects 27 through 30, further comprising: transmitting second control information that schedules a second energy transfer transmission from the second network entity to the EH-capable device in a second set of communication resources, wherein the first control information schedules the energy transfer transmission in a first set of communication resources, wherein the first information indicates the second set of communication resources in which the second network entity is capable of performance of the second energy transfer transmission from the second network entity to the EH-capable device.

Aspect 32: The method of any of aspects 27 through 31, further comprising: receiving, from the second network entity, an indication of a set of network entities capable of performance of energy transfer transmissions to the EH-capable device; and transmitting, to one of the set of network entities, second control information that schedules a second energy transmission from the one of the set of network entities to the EH-capable device.

Aspect 33: The method of any of aspects 27 through 32, further comprising: receiving, from the EH-capable device, second information that indicates to skip the energy transfer transmission; and transmitting, to the second network entity in response to the second information, second control information that indicates to skip the energy transfer transmission, wherein the first information is responsive to the second control information.

Aspect 34: The method of any of aspects 27 through 33, further comprising: transmitting, to the second network entity, second control information that schedules a second energy transfer transmission from the second network entity to the EH-capable device, wherein the second control information includes an indication for the second network entity to transmit second information if the second network entity will perform the second energy transfer transmission, wherein the second information indicates that the second network entity will transmit the second energy transfer transmission, and wherein the first control information includes an indication for the second network entity to transmit the first information if the second network entity will skip performance of the energy transfer transmission; and receiving, from the second network entity, the second information that indicates the second network entity will perform the second energy transfer transmission.

Aspect 35: A first network node for wireless communication, comprising at least one communication interface; and at least one processor coupled to the communication interface, wherein the first network node is configured to perform a method of any of aspects 1 through 14.

Aspect 36: A first network entity for wireless communications, comprising at least one means for performing a method of any of aspects 1 through 14.

Aspect 37: non-transitory computer-readable medium having code for wireless communication stored thereon that, when executed by a first network entity, causes the first network entity to perform a method of any of aspects 1 through 14.

Aspect 38: An EH-capable device for wireless communications, comprising at least one communication interface; and at least one processor coupled to the communication interface, wherein the EH-capable device is configured to perform a method of any of aspects 15 through 26.

Aspect 39: An EH-capable device for wireless communications, comprising at least one means for performing a method of any of aspects 15 through 26.

Aspect 40: non-transitory computer-readable medium having code for wireless communication stored thereon that, when executed by an EH-capable device, causes the EH-capable device to perform a method of any of aspects 15 through 26.

Aspect 41: A first network node for wireless communication, comprising at least one communication interface; and at least one processor coupled to the communication interface, wherein the first network node is configured to perform a method of any of aspects 27 through 34.

Aspect 42: A first network entity for wireless communications, comprising at least one means for performing a method of any of aspects 27 through 34.

Aspect 43: non-transitory computer-readable medium having code for wireless communication stored thereon that, when executed by a first network entity, causes the first network entity to perform a method of any of aspects 27 through 34.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference is made to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network entity for wireless communication, comprising:
at least one communication interface; and
at least one processor coupled to the at least one communication interface, wherein the first network entity is configured to:
receive first control information that schedules an energy transfer transmission from the first network entity to an energy harvesting (EH)-capable device; and
transmit first information including an indication that that the first network entity will skip performance of at least a portion of the energy transfer transmission scheduled by the first control information.

2. The first network entity of claim 1, wherein the first network entity is configured to:
receive second control information indicative of a communication resource for transmission of the first information.

3. The first network entity of claim 1, wherein the first control information schedules a plurality of energy transfer transmissions from the first network entity to the EH-capable device, wherein the plurality of energy transfer transmissions includes the energy transfer transmission.

4. The first network entity of claim 1, wherein the first control information schedules the energy transfer transmission in a set of communication resources, and wherein the portion is a first subset of communication resources of the set of communication resources.

5. The first network entity of claim 4, wherein the first network entity is configured to:
perform the energy transfer transmission via a second subset of the set of communication resources.

6. The first network entity of claim 1, wherein the first control information schedules the energy transfer transmission in a first set of communication resources, and wherein the first information includes an indication of a second set of communication resources in which the first network entity is capable of a second energy transfer transmission from the first network entity to the EH-capable device.

7. The first network entity of claim 1, wherein the first information includes an indication of a set of network entities capable of energy transfer transmissions to the EH-capable device.

8. The first network entity of claim 1, wherein the first network entity is configured to:
receive second control information that schedules a second energy transfer transmission from the first network entity to the EH-capable device, wherein the second control information includes an indication for the first network entity to transmit second information if the first network entity will perform the second energy transfer transmission, wherein the second information indicates that the first network entity will transmit the second energy transfer transmission, and wherein the first control information includes an indication for the first network entity to transmit the first information if the first network entity will skip performance of the energy transfer transmission;
transmit the second information; and
perform the second energy transfer transmission.

9. The first network entity of claim 1, wherein the first network entity is configured to:
receive, from the EH-capable device, second information including a first indication to skip performance of the energy transfer transmission, wherein, to transmit the first information, the first network entity is configured to transmit, based on the second information, the first information.

10. The first network entity of claim 9, wherein the first network entity is configured to:
perform a second energy transfer transmission a period of time after the scheduled energy transfer transmission, wherein the second information includes a request for performance of the second energy transfer transmission after the period of time after the scheduled energy transfer transmission.

11. The first network entity of claim 10, wherein the second information indicates a second set of communication resources for performance of the second energy transfer transmission, wherein the first control information schedules the energy transfer transmission in a first set of communication resources, and wherein the second set of communication resources is subsequent to the first set of communication resources by the period of time.

12. The first network entity of claim 10, wherein the second information indicates the period of time using a unit of time in accordance with a codebook.

13. The first network entity of claim 10, wherein the second information indicates a component carrier for performance of the second energy transfer transmission after the period of time, a frequency band for performance of the second energy transfer transmission after the period of time, a transmission configuration indicator state for performance of the second energy transfer transmission after the period of time, a source network entity to perform the second energy transfer transmission after the period of time, an energy harvesting configuration associated with the second energy transfer transmission, or a combination thereof.

14. The first network entity of claim 1, wherein to transmit the first information, the first network entity is configured to:
transmit the first information to the EH-capable device, a second network entity from which the first network entity received the first control information, or a third network entity capable of performance of a second energy transfer transmission to the EH-capable device.

15. An energy harvesting (EH)-capable device for wireless communication, comprising:
at least one communication interface; and
at least one processor coupled to the at least one communication interface, wherein the EH-capable device is configured to:
receive first control information that schedules an energy transfer transmission from a first network entity to the EH-capable device; and
receive, from the first network entity, first information including an indication that the first network entity will skip performance of at least a portion of the energy transfer transmission scheduled by the first control information.

16. The EH-capable device of claim 15, wherein the EH-capable device is configured to:
transmit, to the first network entity, second information including a first indication to skip the energy transfer transmission, wherein the first information is responsive to the second information.

17. The EH-capable device of claim 16, wherein the EH-capable device is configured to:
identify that an energy level of the EH-capable device satisfies a threshold, wherein to transmit the second information, the EH-capable device is configured to transmit, based on the identification, the second information.

18. The EH-capable device of claim 16, wherein the EH-capable device is configured to:
receive scheduling information for a communication, wherein the communication conflicts with the energy transfer transmission, and wherein to transmit the second information, the EH-capable device is configured to transmit, based on the communication conflicting with the energy transfer transmission, the second information.

19. The EH-capable device of claim 16, wherein the EH-capable device is configured to:
receive a second energy transfer transmission after a period of time after the scheduled energy transfer transmission, wherein the second information includes a request for performance of the second energy transfer transmission after the period of time after the scheduled energy transfer transmission.

20. The EH-capable device of claim 19, wherein the second information includes an indication of a second set of communication resources for performance of the second energy transfer transmission, wherein the first control information schedules the energy transfer transmission in a first set of communication resources, and wherein the second set of communication resources is subsequent to the first set of communication resources by the period of time.

21. The EH-capable device of claim 19, wherein the second information indicates the period of time using a unit of time in accordance with a codebook.

22. The EH-capable device of claim 19, wherein the second information includes an indication of a component carrier for performance of the second energy transfer transmission after the period of time, a frequency band for performance of the second energy transfer transmission after the period of time, a transmission configuration indicator state for performance of the second energy transfer transmission after the period of time, a source network entity to perform the second energy transfer transmission after the period of time, an energy harvesting configuration associated with the second energy transfer transmission, or a combination thereof.

23. The EH-capable device of claim 15, wherein the first control information schedules a plurality of energy transfer transmissions from the first network entity to the EH-capable device, wherein the plurality of energy transfer transmissions includes the energy transfer transmission.

24. The EH-capable device of claim 15, wherein the first control information schedules the energy transfer transmission in a set of communication resources, and wherein the portion is a first subset of communication resources of the set of communication resources.

25. The EH-capable device of claim 24, wherein the EH-capable device is configured to:
receive the energy transfer transmission via a second subset of the set of communication resources.

26. The EH-capable device of claim 15, wherein the first control information schedules the energy transfer transmission in a first set of communication resources, wherein the first information includes an indication of a second set of communication resources in which the first network entity is capable of performance of a second energy transfer transmission from the first network entity to the EH-capable device.

27. A first network entity for wireless communication, comprising:
at least one communication interface; and
at least one processor coupled to the at least one communication interface, wherein the first network entity is configured to:
transmit, to a second network entity, first control information that schedules an energy transfer transmission from the second network entity to an energy harvesting (EH)-capable device; and
receive, from the second network entity, first information including an indication that the second network entity will skip performance of at least a portion of the energy transfer transmission scheduled by the first control information.

28. The first network entity of claim 27, wherein the first network entity is configured to:
transmit, to the second network entity, second control information indicative of a communication resource for transmission of the first information, wherein the first information is received via the communication resource.

29. The first network entity of claim 27, wherein the first control information schedules a plurality of energy transfer transmissions from the second network entity to the EH-capable device, wherein the plurality of energy transfer transmissions includes the energy transfer transmission.

30. A method for wireless communications at a first network entity, comprising:
receiving first control information that schedules an energy transfer transmission from the first network entity to an energy harvesting (EH)-capable device; and
transmitting first information including an indication that that the first network entity will skip performance of at least a portion of the energy transfer transmission scheduled by the first control information.
